(19) United States
(12) Patent Application Publication
(10) Pub. No.: US 2026/0179100 A1
(43) Pub. Date: Jun. 25, 2026

(54) CUSTOMIZED DATA MANAGEMENT SYSTEMS AND METHODS WITH ARTIFICIAL INTELLIGENCE PLATFORM

(71) Applicant: State Farm Mutual Automobile Insurance Company, Bloomington, IL (US)

(72) Inventors: Phillip M. Wilkowski, Gilbert, AZ (US); Alexander Cardona, Gilbert, AZ (US); Laura A. Uphoff, Gilbert, AZ (US); Daniel Wilson, Phoenix, AZ (US)

(21) Appl. No.: 19/408,634

(22) Filed: Dec. 4, 2025

Related U.S. Application Data
(60) Provisional application No. 63/738,033, filed on Dec. 23, 2024.

(51) Int. Cl. G06Q 20/42

(52) U.S. Cl. CPC G06Q 20/42

(57) ABSTRACT

Systems and methods for customized data management (CDM) may include: (i) establishing a communication link with a computing device associated with a user account of a user; (ii) receiving user data from the user account via the communication link; (iii) executing a CDM tool to actively monitor the user account, wherein the CDM tool includes a user-specific artificial intelligence (AI) model trained based upon historical user data associated with the user and the user account; (iv) detecting, by the CDM tool, that the user account requires a managed response to an event associated with the user account; (v) in response to the detected event, generating the managed response using the user-specific AI model and without contemporaneous input from the user, the managed response satisfying a condition associated with the detected event; and/or (vi) transmitting, via the communication link, the managed response to the computing device associated with the user account.

### CROSS-REFERENCE TO RELATED APPLICATIONS

This application claims the benefit of priority to U.S. Provisional Ser. No. 63/738,033 , filed Dec. 23, 2024, entitled “CUSTOMIZED DATA MANAGEMENT SYSTEMS AND METHODS WITH ARTIFICIAL INTELLIGENCE PLATFORM,” the entire content and disclosure of which is hereby incorporated herein by reference in its entirety.

### FIELD OF THE DISCLOSURE

The field of the disclosure relates generally to artificial intelligence (AI) and digital management systems, and more specifically, to customized data management systems and methods with an artificial intelligence-based platform for managing electronic documents and/or records associated with a user.

### BACKGROUND

Modern-day living may include so-called digital lifestyle aspects such as emails, calendaring, scheduling, travel bookings, in-store or online transactions, and/or other electronic documents or records of a user, both within a person's personal and professional (e.g., work) capacities. For example, a parent may have personal and work email accounts, and may schedule events for themself either personally or professionally and/or for other family members.

It may be a time consuming job to just manage the electronic documents associated with the personal life plans of certain people such as school schedules, extracurricular activities, sporting events, etc., let alone work schedules and obligations for those same people. For example, in the normal course of daily life, a family of four may need to manage a plurality of sports and/or personal activity schedules for children which may include practices during different nights of the work week and multiple events during the weekends. In the professional/work setting, a business professional may manage several clients and have overlapping due dates for each of such clients, where each due date needs to be precisely managed and have a proper amount of attention paid thereto. Other related events that may need to be scheduled and accounted for may include transportation and travel plans. These related events may also present their own set of challenges in connection with booking and/or checking into flights and hotels.

Additionally, managing personal and/or professional expenses including payments and transactions may be a challenging and time consuming task. Consumers may be inundated with authentication requests, such as one-time password (OTP), biometric, and/or password/PIN authentication requests for any given transaction, which, while providing enhanced security, may still amount to an annoyance and introduce frustrations in completing such transactions.

Even with modern electronic email, calendaring, and/or professional software such as docketing systems used for setting reminders and/or managing due dates, the amount of communications and tasks requiring attention may be overwhelming. Existing systems may be static in nature and incapable of adequately sorting urgent, pressing, or important communications from less urgent, pressing, or important communications. In the case of an email inbox that receives communications for managing a plurality of business clients, this may contribute to items that may require immediate or additional attention as compared to other emails being buried amongst less urgent, less pressing, or less important messages that do not need immediate action or extra attention. Conventional systems may include additional ineffectiveness, encumbrances, inefficiencies, and/or other drawbacks as well.

### BRIEF DESCRIPTION OF THE DISCLOSURE

The present embodiments may relate to, inter alia, a customized data management system that may efficiently and effectively manage voluminous transactions and related notifications/requests; update schedules; prioritize urgent, pressing, or important communications; and respond to communications in real-time and automatically, via a streamlined AI tool. More specifically, the computer systems and computer-based methods described herein may provide a customized data management (CDM) tool that learns individual habits and events including purchases (e.g., shopping habits, etc.), hobbies (e.g., kid's sports, etc.), travel, calendars, and emails of one or more users, and assists the users in handling tasks related to such habits, events and emails. The CDM tool may be a computing system that may include (i) a backend computing system capable of ingesting data from a plurality of different sources and having intelligence such as one or more AI models configured to extrapolate the data, provide insights into the data, and output results of such insights to electronic devices of one or more users, (ii) one or more client devices, (iii) one or more (e.g., third party) servers, (iv) one or more databases, and/or (v) one or more connected services.

In at least one embodiment, a CDM system for providing customized data management may be provided. The CDM system may include one or more local or remote computers, processors, servers, sensors, transceivers, mobile devices, wearables, smart watches, smart contact lenses, voice bots, chat bots, artificial intelligence (e.g., ChatGPT) bots, augmented reality glasses, virtual reality headsets, mixed or extended reality headsets or glasses, and other electronic or electrical components, which may be in wired or wireless communication with one another, and operate as input and/or output devices. For example, in one instance, the CDM computer system may include one or more processors programmed to: (a) establish a communication link with a computing device associated with at least one user account of a plurality of user accounts associated with a user; (b) receive user data from the at least one user account via the communication link; (c) execute a CDM tool to actively monitor the at least one user account, wherein the CDM tool includes a user-specific artificial intelligence (AI) model trained based upon historical user data associated with the user and the at least one user account; (d) detect, by the CDM tool and the received user data, that the least one user account requires a managed response to an event associated with the at least one user account; (e) in response to the detected event, generate the managed response using the user-specific AI model and without contemporaneous input from the user, the managed response satisfying a condition associated with the detected event; and/or (f) transmit, via the communication link, the managed response to the computing device associated with the at least one user account. The CDM system may include additional, less, or alternate functionality, including that discussed elsewhere herein.

In another embodiment, a computer-implemented method for providing customized data management may be provided. The method may be implemented using one or more local or remote processors, servers, sensors, transceivers, mobile devices, wearables, smart watches, smart contact lenses, voice bots, chat bots, artificial intelligence (e.g., ChatGPT) bots, augmented reality glasses, virtual reality headsets, mixed or extended reality headsets or glasses, and other electronic or electrical components, which may be in wired or wireless communication with one another, and operate as input and/or output devices. For example, the method may include: (a) establishing a communication link with a computing device associated with at least one user account of a plurality of user accounts associated with a user; (b) receiving user data from the at least one user account via the communication link; (c) executing a CDM tool to actively monitor the at least one user account, wherein the CDM tool includes a user-specific artificial intelligence (AI) model trained based upon historical user data associated with the user and the at least one user account; (d) detecting, by the CDM tool and the received user data, that the least one user account requires a managed response to an event associated with the at least one user account; (e) in response to the detected event, generating the managed response using the user-specific AI model and without contemporaneous input from the user, the managed response satisfying a condition associated with the detected event; and/or (f) transmitting, via the communication link, the managed response to the computing device associated with the at least one user account. The method may include additional, less, or alternate actions, including those discussed elsewhere herein.

In still another embodiment, one or more non-transitory computer-readable storage media having computer-executable instructions embodied thereon for providing customized data management may be provided. The computer-executable instructions may be implemented using one or more local or remote processors, servers, sensors, transceivers, mobile devices, wearables, smart watches, smart contact lenses, voice bots, chat bots, artificial intelligence (e.g., ChatGPT) bots, augmented reality glasses, virtual reality headsets, mixed or extended reality headsets or glasses, and other electronic or electrical components, which may be in wired or wireless communication with one another, and operate as input and/or output devices. For example, when executed by at least one processor, the computer-executable instructions cause the at least one processor to: (a) establish a communication link with a computing device associated with at least one user account of a plurality of user accounts associated with a user; (b) receive user data from the at least one user account via the communication link; (c) execute a CDM tool to actively monitor the at least one user account, wherein the CDM tool includes a user-specific artificial intelligence (AI) model trained based upon historical user data associated with the user and the at least one user account; (d) detect, by the CDM tool and the received user data, that the least one user account requires a managed response to an event associated with the at least one user account; (e) in response to the detected event, generate the managed response using the user-specific AI model and without contemporaneous input from the user, the managed response satisfying a condition associated with the detected event; and/or (f) transmit, via the communication link, the managed response to the computing device associated with the at least one user account. The computer readable medium may have instructions that direct additional, less, or alternate functionality, including that discussed elsewhere herein.

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

### BRIEF DESCRIPTION OF THE DRAWINGS

The Figures described below depict various aspects of the systems and methods disclosed therein. It should be understood that each Figure depicts an embodiment of a particular aspect of the disclosed systems and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed herein. However, it should be understood that the present embodiments are not limited to the precise arrangements and/or instrumentalities shown herein.

FIG. 1 illustrates a diagram of an exemplary customized data management (CDM) system in accordance with at least one embodiment of the present disclosure.

FIG. 2 illustrates a diagram for an exemplary computing system within the CDM system shown in FIG. 1.

FIG. 3 illustrates a diagram of an exemplary data flow for model building, training, testing, and deployment, in accordance with at least one embodiment of the present disclosure.

FIG. 4 illustrates a diagram of an exemplary user interface for user terminals, in accordance with at least one embodiment of the present disclosure.

FIG. 5 illustrates a diagram of an exemplary ranking procedure, in accordance with at least one embodiment of the present disclosure.

FIG. 6 illustrates a flow chart of an exemplary computer-implemented method implemented by the system and components shown in FIGS. 1 and 2.

FIG. 7 illustrates a block diagram of an embodiment of a data processing system in which the computing system and components thereof shown in FIGS. 1 and 2 may be implemented.

FIG. 8 illustrates a block diagram of an embodiment of an exemplary computer system in which the user terminals shown in FIG. 1 may be implemented.

FIG. 9 illustrates a flow chart of an exemplary computer-implemented method implemented by the system and components shown in FIGS. 1 and 2 in connection with user emails.

FIG. 10 illustrates a flow chart of an exemplary computer-implemented method implemented by the system and components shown in FIGS. 1 and 2 in connection with user calendars.

FIG. 11 illustrates a flow chart of an exemplary computer-implemented method implemented by the system and components shown in FIGS. 1 and 2 in connection with user transportation.

FIG. 12 illustrates a flow chart of an exemplary computer-implemented method implemented by the system and components shown in FIGS. 1 and 2 in connection with user lodging.

FIG. 13 illustrates a flow chart of an exemplary computer-implemented method implemented by the system and components shown in FIGS. 1 and 2 in connection with user spending, transactions, and payments.

The Figures depict preferred embodiments for purposes of illustration only. One skilled in the art will readily recognize from the following discussion that alternative embodiments of the systems and methods illustrated herein may be employed without departing from the principles of the disclosure described herein.

### DETAILED DESCRIPTION OF THE DISCLOSURE

The exemplary embodiments described herein may relate to, inter alia, artificial intelligence (AI)-based systems and methods for customized data management using a CDM system. In one exemplary embodiment, the CDM system may include a customized data management backend device connected to a frontend device, which may be configured as a generative AI system capable of generating content including, but not limited to, text, images, audio, video and/or other data. In some embodiments, the CDM backend may be executed by a computer device and/or server that manages communications with a plurality of external users and/or systems. The CDM backend may transmit individual digital data to connected components and/or systems that propagate and analyze the individual digital data to generate models, and the models are used to interact with and/or control aspects of various user accounts including emails, calendars, transportation, lodging, and payment accounts, and/or automatically respond to communications on behalf of or acting as a user, without having to ask a user for direct input, and based upon the user's history/behaviors/preferences.

The CDM system may also manage transaction approval for transactions made by a user based upon one or more approval factors, and may automatically approve transactions without having to ask a user for direct input, but instead approve the transactions based upon the user's transaction history/behaviors/preferences/settings. In the exemplary embodiment, the models used within the CDM system may be artificial intelligence-based models. In some embodiments, the models may utilize machine learning (ML). In some embodiments, the models generate responses by understanding an intent and/or meaning of text or audio inputted into the models, and then generate a response including text, audio, images, video, or other outputs.

### Exemplary Customized Data Management System

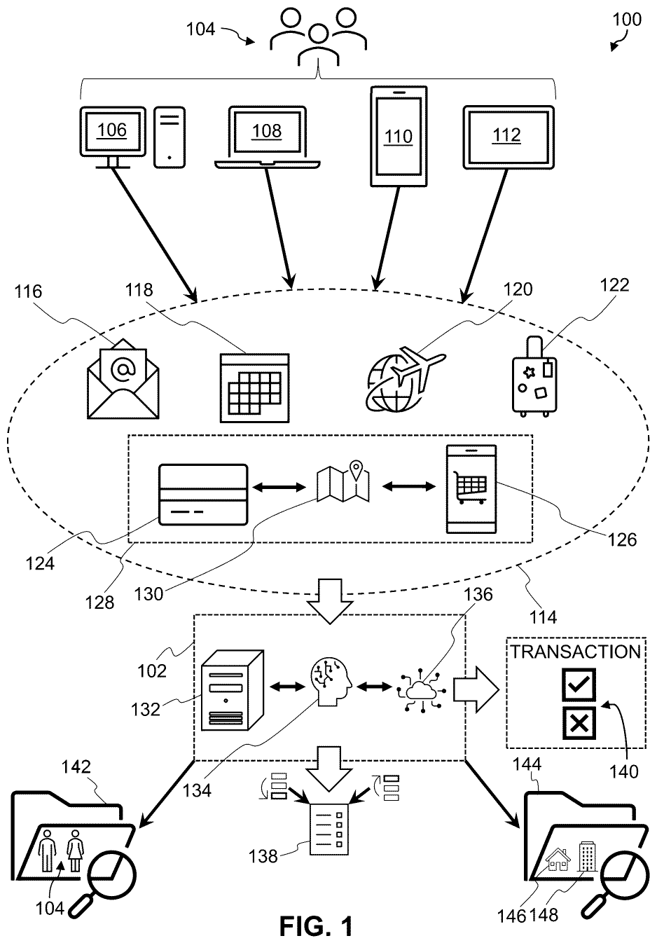

FIG. 1 illustrates a block diagram of an exemplary customized data management (CDM) system 100 in accordance with at least one embodiment of the present disclosure. In the exemplary embodiment, the CDM system 100 includes a computing system 102 that may be configured to receive data from one or more electronic devices associated with one or more users 104 as part of a customized data management tool that is implemented and executed by computing system 102. Computing system 102 may be configured as a backend computing system. The one or more electronic devices of users 104 may include one or more user terminals including a desktop computer 106, a laptop computer 108, a mobile communication device 110 such as a mobile phone, and/or a mobile computing device such as a tablet computer 112, or other computing devices. Each of electronic devices 106, 108, 110, and 112 may be associated with personal accounts of a user 104 and/or third-party services used by a user 104, and work accounts of a user 104 and/or work third-party services used by a user 104.

In some embodiments, third-party services may include third-party software such as commercially available email and calendaring software, and online accounts and access thereof for accounts such as bank accounts, payment card (e.g., credit card) accounts, transportation accounts such as airline and rideshare accounts, lodging (e.g., hotel) accounts, and/or retailer accounts. Each of the airline, hotel, and/or retailer accounts may include corresponding loyalty accounts of respective loyalty programs of the airlines, hotels, and/or retailers.

In the exemplary embodiment, computing system 102 may be configured to collect data from the third-party services used by a user 104 via their various electronic devices (e.g., 106-112) based upon a plurality of rules and/or other information stored within one or more databases of or associated with the CDM system 100. Computing system 102 may be configured to link to and integrate with the third-party services to have access to individual digital data 114 such as emails, calendar schedules, travel bookings, and transactions. The third-party services may include (i) email accounts 116, (ii) digital calendar accounts 118, (iii) transportation accounts 120, (iv) lodging (e.g., hotel) accounts 122, and (v) payment accounts including payment card accounts 124 (e.g., primarily for card present (CP) payment transactions) and digital payment accounts 126 (e.g., primarily card not present (CNP) payment transactions such as online transactions and/or digital wallet transactions), in order to learn about each user and be able to perform customized data management tasks.

Payment card accounts 124 and digital payment accounts 126 may be generally and collectively referred to herein as “payment accounts.” Individual digital data 114 may include transaction data 128 resulting from transactions made via payment accounts 124, 126. Geolocation data 130 of a given user 104 may be used in association with transaction data of transactions resulting from usage of payment accounts 124, 126.

In some embodiments, geolocation data 130 may be used as part of an automated approval function performed by CDM system 100 for approval of transactions of a user 104, as described later. Geolocation data 130 may be determined based upon triangulation of an electronic device of a user 104, such as via GPS and/or network-based (e.g., cell tower) location of mobile communication device 110, and/or a location of a point-of-sale (“POS”) terminal in which a payment card of user 104 is used to make a payment card (e.g., CP) transactions via a payment card associated with payment card accounts 124 and/or at which mobile communication device 110 is used in a tap-to-pay transaction associated with digital payment accounts 126. In some embodiments, payment card accounts 124 and digital payment accounts 126 may be associated with a common service provider such as a common issuer/provider of both the physical payment card and a digital wallet associated with the physical payment card. In other embodiments, payment card accounts 124 and digital payment accounts 126 may be provided by different entities.

In the exemplary embodiment, computing system 102 may include one or more computing devices 132, one or models 134 (AI/ML models) implemented via computing devices 132, and a software platform 136 for implementing models 134 with external services such as third-party services including those services providing accounts 116-126 and performing other tasks as described herein. The one or more models 134 are implemented and used by computing devices 132 to perform CDM for users 104 via platform 136. In some embodiments, computing device 132 may be a computer configured with sufficient software and hardware to build, train/re-train, and deploy models 134 for live action, as described in more detail below.

In the exemplary embodiment, models 134 may be artificial intelligence models that may utilize machine learning to learn about behaviors, preferences, writing styles, etc. of users 104 in connection with their use of one or more of accounts 116-126 via ingesting and analyzing individual digital data 114, described in more detail below. In some embodiments, model 134 may be a large language model (LLM) configured to provide generative outputs, and may be in the form of a virtual assistant or chatbot. In some embodiments, platform 136 may function as a CDM tool and be cloud-based software that runs code in response to events and automatically manages email responses, calendars, scheduling, transaction approval, and/or future bookings, acting on behalf of a user 104 via model 134, as described in more detail below. In some embodiments, models 134 may include individual models that are directed to a single user 104, or group models directed to a group of users 104.

In the exemplary embodiment, computing devices 132 may be configured with hardware and software configured to sufficiently build, train/re-train, and deploy models 134. In some embodiments, computing devices 132 may be configured in a distributed computing configuration and/or to utilize parallel processing for resource intensive tasks such as building, training and/or deploying live models 134.

In the exemplary embodiment, models 134 may be generally trained on a large data set of individual digital data from a wide userbase and then re-trained using individualized user data such as individual digital data 114 for a given user 104 and/or household including a set of users 104, so that models 134 are unique to each user 104 and/or the corresponding household. These customized AI models are better able to predict user responses to inputted electronic data.

In the exemplary embodiment, software platform 136 is a tool (e.g., a CDM tool) that may be integrated with and/or fully or partially operatively connected to computing system 102 of CDM system 100. Platform 136 may be integral with and implemented via one or more computing devices 132 and/or one or more external computing devices (not shown). Platform 136 may be configured to perform a variety of functions in connection with the implementation of the computing system 102, such as at the user level. For example, platform 136 may function in whole or in part as a cloud-based software platform configured to align with and integrate with third-party offerings/services such as accounts 116-126, and generally include (i) third-party email programs, (ii) third-party calendar programs, and/or (iii) online access accounts such as bank accounts and/or other payment accounts (e.g., credit card accounts, digital wallet accounts), transportation accounts, and/or hotel accounts.

Aspects of software platform 136 may be implemented on electronic devices 106-112 and/or linked to and/or integrated with the third-party accounts via one or more plug-ins, APIs, and/or other granted permissions. Platform 136 may include a front-end/front-facing user interface to allow a user 104 to set up and customize platform 136 to their individual preferences and/or group (e.g., household) preferences. In operation, platform 136 may be configured to actively monitor various aspects of accounts 116-126, as described in more detail below.

In the exemplary embodiment, platform 136 may be configured to output one or more computer-executable files 138 usable with the (e.g., back-end) software that provides accounts 116-122. Files 138 may be used in conjunction with a plug-in or application programming interface (API) associated with the software that provides accounts 116-122 so that model 134 may perform tasks in place of or acting as the user, in a manner that the user would operate when using one or more of accounts 116-122. For example, when a file 138 is utilized in conjunction with email account 116, model 134 may be given permission to read and/or respond to emails.

Other examples of the system described herein may include training the model 134 (e.g., LLM model) to output a call function reservation for a specified restaurant at a specified time. The platform 136, executing the model 134, may perform an API call for the user to schedule the reservation at the specified restaurant and at the specified date and time. The result of this API call can be sent back into the LLM model 134 to give a message that the reservation was successful or unsuccessful. The system described herein may also be used to schedule other events and/or make reservations for travel, hotels, restaurants, and/or other situations where an event may be scheduled and arranged for a person/user. In addition, the system described herein may be used to purchase, schedule and notify a user about tickets for an event. In other words, the system may purchase tickets for an event, like a sporting event or concert, using information provided to the system and preferences of the user and/or household. The tickets may be purchased and provided digitally to the user and calendared for the user to easily track the date. Other examples that the system may be used to carry out may include arranging or managing: (1) shopping/deliveries (e.g., weekly groceries, vendor subscribe and save deliveries); (2) transportation (e.g., public transportation schedules, carpool schedules, etc.); (3) meal planning; (4) health/fitness scheduling (e.g., medication reminders); (5) subscription management/renewal (e.g., video streamers, driver's license, passports); (6) budgeting/finance (e.g., monthly bills); (7) maintenance schedules (e.g., oil changes, furnace, HVAC filters, etc.).

Additionally, the email program associated with email account 116 may be instructed, based upon the contents/instructions of file 138 and/or the operational parameters of model 134, to sort emails in an order of priority as determined by model 134 of computer system 102, based upon learned behavior of the user and/or specific trigger words or other trigger parameters indicative of an urgent or priority email. In some embodiments, file 138 may be an executable file for deploying model 134 for use with any given service used by the user. In other embodiments, file 138 may be a human-readable “to do” list with tasks and/or other events ranked in order of preference or priority, as determined and output by model 134, where file 138 is configured for viewing by a user 104 on electronic devices 106-112.

In the exemplary embodiment, platform 136 may further be configured to perform an approval/denial function 140 to (e.g., automatically) approve/deny transactions made via payment accounts 124, 126, based, for example, on learned behavior of each user 104 via model 134 and when granted permission to make such approvals/denials by a user, as described below in more detail. In some embodiments, platform 136 will be aware of certain spend thresholds and/or other limits that a user 104 may have set within platform 136 and/or in conjunction with bank and/or payment card accounts. For automatic approval of purchases, platform 136 will therefore know that it can automatically approve transactions under a certain amount but not over a certain amount. And even when a bank or payment card provider may send a text or confirmation to the user regarding a given purchase regardless of any threshold settings set in platform 136, platform 136 will know that it can approve (or deny) the transaction based upon such threshold settings.

In the exemplary embodiment, platform 136 may be further configured to generate one or more user profiles for users 104, including individual profiles 142 and group profiles 144. Individual profiles 142 may include a user profile for each individual user 104, regardless of any group affiliation of the user. An individual profile 142 may be an individual personal profile for personal life aspects of a user 104 and/or a work profile for professional life aspects of a user 104. Group profiles 144 may include household profiles 146 and/or work profiles 148, such as a group work profile for a designated department or work sector/unit.

In some embodiments, users 104 may permit CDM system 100, such as via platform 136, to send their electronic devices (e.g., 106-112) various communications and/or other outputs in accordance with user-defined settings and/or any governing rules (e.g., FCC rules regarding data message rates that may apply, help messages, and the ability to opt-out (e.g., by texting “STOP”)). In some embodiments, a user 104 may permit CDM system 100 to respond to communications on behalf of the user. For example, a user 104 may grant permission to a tool or service associated with CDM system 100 to permit CDM system 100 to automatically respond to authentication messages such as two-factor authentication messages on behalf of the user. The computing system 102 may include an associated user interface which may be presented and/or otherwise accessible on electronic devices 106-112 of users 104 so that users 104 may define parameters and permissions granted by the user to the CDM tool/service.

In some embodiments, platform 136 may be configured to provide a user interface for display on electronic devices 106-112 to permit users 104 to customize settings and/or permissions granted to platform 136 with respect to the scope of customized data management for a given user and/or household. For example, a household profile 144 may be set by a managing user of the household profile such that platform 136 only manage travel aspects of the household, but does not manage financials aspects of the household.

In some embodiments, household profile 146 may include a common profile for a group of linked users 104, such as a family of four including two parents and two children within the same household. A household profile 146 may have access to each calendar of each user 104 within the household group profile to assist with approving transactions associated with the group. For example, when the entire family of four is traveling together and their plane lands early, computing device 132 may detect the early landing and schedule a taxi or rideshare even if the members of the family still do not have cellular access (e.g., plane still in flight and user's mobile devices are in airplane mode).

The ride share will nevertheless be ready as the family of four lands due to computing device 132 recognizing the early landing and booking the ride share based upon approval's set within the household profile 144, thus offering great convenience and time-savings to the family of four. In some embodiments, household profile 144 may include a common profile for a group of linked users 104, such as two parents and two children within the same household. A household profile 144 may have access to each calendar of each user 104 within the household group profile to assist with approving transactions associated with the group.

In some embodiments, a single electronic device of a user 104 such as mobile communication device 110 may be configured to have access to both personal and work accounts of the user. In certain embodiments, a user 104 may have separate electronic devices for dedicated personal and work usage. In various embodiments, a user may access a work account from a personal electronic device, and vice versa for accessing a personal account from a work device.

In some embodiments, individual profiles 142 and group profiles 144 may be configured to load a corresponding account profile for the various accounts users 104 have linked with platform 136, such as bank and/or payment card account profiles and/or information. Additionally, any given individual profile 142 and/or group profile 144 may include sub-profiles therein. In one non-limiting example, an individual profile 142 may have a sub-profile directed only to travel. Similarly, in a group profile 144 such as a household profile, there may be a sub-profile directed to family travel plans. Separate spend profiles may also be created as sub-profiles. In one non-limiting example, a household spend sub-profile may track weekly or monthly grocery spend, whereas a personal spend sub-profile may track take-out (e.g., restaurant) spend.

In some embodiments, and additionally or alternatively, CDM system 100 may be configured to process an audio (e.g., voice) message into a text string that is then processed in the manner described herein. For example, individual digital data 114 may include a voice message such as a voice reminder recorded by a user 104 capable of being processed by computing system 102 to extract meaningful information from the voice message for the updating of user schedules and/or models 134.

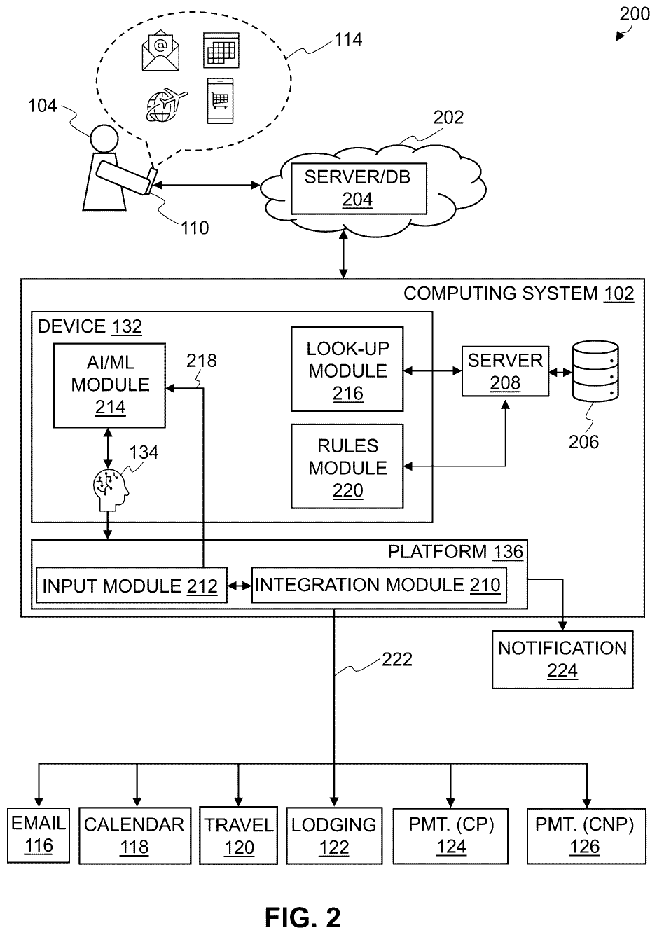

A database similar to that shown in FIG. 2 (described below) may be used to store various data, including data relating to an audio-to-text conversion, and such a database may store both the audio data extracted from the voice message, for comparing words parsed from the audio data to a collection of known words for determining an intent or meaning of the voice message. For example, such a database may include a table of known words, phrases, etc. that can be used as a look-up for the parsing of the words extracted from the voice message and determining a meaning thereof.

Moreover, a chatbot may be implemented as part of computing system 102 such as by way of platform 136 and programmed to handle audio-to-text conversion tasks and/or to assist the other modules in translating or otherwise processing the audio data from the voice message into text and/or to determine an intent of the words extracted from the audio data. The text resulting from such audio-to-text conversions may then be used in the manner described herein for customized data management.

The CDM system 100 and the processes described herein represent an improvement over conventional digital data management by way of at least providing both personal and/or household profiles, each of which are individualized to the person and/or household, providing AI tools to automatically analyze and respond to electronic records (both personal and work related) received by the user computing devices, and/or causing automatic and real-time updating of scheduling and financial data of the person/household.

### Exemplary Customized Data Computing System

FIG. 2 illustrates a diagram 200 of components used as part of and/or in conjunction with computing system 102 of CDM system 100 (shown in FIG. 1). In the exemplary embodiment, customized data management is performed by the computing system 102 (shown in FIG. 1).

In the exemplary embodiment, a user 104 and/or a household of users may install on one or more of electronic devices 106-112 computer software that provides access to platform 136, and then using a user interface of the software, enables platform 136 to have access to their various third party accounts 116-126 that they desire to be managed by platform 136. Platform 136 may then link with and integrate with the various connected third party services to begin the process of generating customized models 134 for a given user 104 using user-specific training data, such as existing data imported from third party accounts 116-126. Over time, platform 136 may ingest new data derived from usage of one or more of accounts 116-126 for subsequent updating of model 134.

To accomplish this, in the exemplary embodiment, computing system 102 may be configured to access individual digital data 114 of a user 104 via network 202 and one or more network-connected servers/databases 204 associated with the storage of and providing access to individual digital data 114 from the respective accounts 116-126 selected by the user for use with platform 136. For example, each respective service from the providers of email accounts 116, transportation accounts 120, lodging accounts 122, payment cards associated with payment card accounts 124, and digital wallets associated with the digital payment accounts 126 may be associated with a respective server/database 204 for the storing of and/or access to user data relating to the user's use of each corresponding service, where computing system 102 may be configured to access such data via network 202.

In the exemplary embodiment, computing system 102 may include hardware and software configured to facilitate the receipt and processing of individual digital data 114 as described herein, and may include one or more computing devices 132, one or more databases 206, and one or more servers 208 operatively connected to the one or more databases 206. Computing system 102 may include various software modules for performing main processing tasks, including but not limited to an integration module 210, an input module 212, an AI/ML module 214, a look-up module 216, and a rules module 220. Input module 212 may be operatively connected with AI/ML module 214 to provide data such as individual digital data 114 to AI/ML module 214 for use in building and training/re-training models 134. Platform 136 may be provided within computing system 102 as part of and/or integrated with one or more of computing devices 132 and configured to output data 222 to the various services (e.g., that provide accounts 116-126) to update and/or use the services as if model 134 were the user and to generate and output user notifications 224 to users 104 in connection with the CDM tasks performed by platform 136.

In the exemplary embodiment, network 202 may be any data/communications network including but not limited to the Internet as provided by one or more internet service providers (ISPs) and to which electronic devices 106-112, server/database 204, and computing system 102 is/are connected to. In some embodiments, network 202 may include a local-or-wide-area network (LAN or WAN, respectively), and/or a cellular-or satellite-based network. In some embodiments, network 202 may include a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)). Network 202 may be configured as a combination of one or more of the network types and/or to implement aspects of the one or more network types described herein.

In the exemplary embodiment, server/database 204 may be a server/database hardware and software configured to provide access to and store data of one or more of the accounts 116-126. For example, a provider of the email service that provides email account 116 may provide/operate a server/database 204 for providing access to and storing email data, a provider of a transportation account 120 may provide/operate a server/database 204 for providing access to and storing transportation account data, and so on and so forth for the other accounts 118, 122, 124, 126 and their respective providers.

In the exemplary embodiment, database 206 may be a computer-operated hardware and software suitable for storing and/or retrieving data and may be configured as one or more storage devices configured to store and/or retrieve operating data for the operation of CDM system 100 and specifically for the operation of computing system 102. Database 206 may also be configured to store/retrieve other data including but not limited to individual digital data 114 for building, training, re-training, and/or otherwise updating models 134. In some embodiments, database 206 may be integral to computing system 102. In other embodiments, database 206 may be external to computing system 102, but still operatively connected to computing system 102.

In some embodiments, database 206 may be configured as cloud-based or local storage, or a hybrid thereof. In some embodiments, database 206 may include a storage area network (SAN), a network attached storage (NAS) system, and/or multiple storage units such as hard disks and/or solid-state disks in a redundant array of inexpensive disks (RAID) configuration. In certain embodiments, database 206 may be configured as a relational database (e.g., MySQL, PostgreSQL) or a NoSQL database (e.g., MongoDB) depending on the nature and scale of the data.

In various embodiments, database 206 may be operatively coupled to other devices via a storage interface, where the storage interface may be any component capable of providing other devices with access to database 206. The storage interface may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing devices with access to database 206. In some embodiments, database 206 may be configured to comply with security protocols and privacy regulations, including secure data transmission using encryption protocols such as SSL/TLS, secure storage, and access controls.

In the exemplary embodiment, server 208 is a computer server configured to process requests and deliver data to other computers over network 202 such as between computing device 132 and database 206. Server 208 may include one or more processors (e.g., CPUs), which may be multi-core, high-speed processors designed for parallel processing, one or more memory devices including but not limited to RAM and/or other storage such as high-capacity and high-speed storage solutions, such as SSDs (Solid State Drives) and HDDs (Hard Disk Drives), often configured in RAID (Redundant Array of Independent Disks) for redundancy and performance.

Server 208 may include one or more network interfaces, such as high-speed network interfaces including Ethernet ports for data communication, and be powered by a power supply which may include redundant power supplies to ensure continuous operation. Server 208 may be configured with an operating system such as a server-grade operating system, and server Applications for providing services such as database management (e.g., MySQL, PostgreSQL), and file sharing (e.g., FTP servers) and file transfer. Server 208 may be configured to handle data queries, store and manage files for access over a network, run software applications, and/or be otherwise optimized for a specific role(s).

In the exemplary embodiment, integration module 210 is a software module and configured to link to and integrate with backend systems of the various service providers that provide accounts 116-126. In some embodiments, integration module 210 may be configured as an API integration module capable of establishing a communication link with and interfacing with a variety of different systems of the providers of accounts 116-126 to facilitate data exchange from one or more of accounts 116-126 to computing system 102, so that individual digital data 114 from the respective accounts is obtained for use in connection with models 134 and platform 136. A communication link may refer both to a link generated by way of a plug-in or an API. Integration module 210 may be configured to link to and integrate with the systems associated with accounts 116-126 both for obtaining individual digital data 114 and for implementing models 134 in conjunction with accounts 116-126, such as in the case when model 134 is configured to automatically approve transactions associated with a user's usage of payment accounts 124, 126.

In the exemplary embodiment, input module 212 is a software module and configured integrally within computing system 102 to intake and process individual digital data 114. Input module 212 may, in conjunction with integration module 210, be configured to link to multiple data sources such as data sources associated with accounts 116-126 to securely access and retrieve individual digital data 114 from each account. Input module 212 may be configured to intake, parse, and/or otherwise process data including individual digital data 114 to extract relevant information from the data sources. For example, for emails this may include extracting and processing information regarding sender, recipient, subject, body, attachments, etc.

For calendars, this may include extracting and processing information relating to event details, participants, etc. For transactions, this may include extracting and processing dates, times, amounts, and locations of transactions.

Input module 212 may be configured to process the received data, which may be in the form of “raw” data, into a structured format, for example, and store the data within database 206 in formats useful for efficient and effective querying. This may include standardizing and/or otherwise normalizing data from the different sources to ensure consistency, such as converting different date formats into a unified format. In some embodiments, input module 212 may be configured with a scheduler function to manage periodic data fetching tasks to keep aggregated data in database 206 up-to-date. In some embodiments, input module 212 may be configured to perform error handling and logging, to track and/or log any errors encountered during data retrieval or processing to ensure reliability and to facilitate troubleshooting.

In the exemplary embodiment, AI/ML module 214 is a software module and configured integrally within computing system 102 for the building, training, deploying, and/or re-training of model(s) 134 using individual digital data 114 from a given user/users 104 and/or for a given household including a set of given users 104. AI/ML module 214 may be configured to receive processed data 218 output from input module 212, where processed data 218 output from input module 212 may include processed individual digital data 114.

In some embodiments, AI/ML module 214 may further be configured to perform other preprocessing of data 218 output from input module 212 prior to use of data 218 with models 134, which may include additional data cleaning such as handling missing values and outlier removal, and/or further normalization and transformation to make data 218 more suitable for training. In other embodiments, such preprocessing may be performed by input module 212.

The building and training of models 134 by AI/ML module 214 may include parameter and/or feature engineering, which may include creation of features from raw data input into input module 212 or from data 218 output from input module 212 to improve model performance, as well as model selection, including selecting a suitable algorithm (e.g., linear regression, decision trees, neural networks). Training of models 134 by AI/ML module 214 may include running the algorithm on the dataset (e.g., data 218) to adjust model parameters and perform evaluation of the model.

Model evaluation performed by AI/ML module 214 may include performing validation, such as by splitting the dataset into training and validation sets to evaluate model performance, and evaluating various metrics for model accuracy, precision, and the like. In some embodiments, validating the model also includes fine-tuning parameters based upon evaluation metrics. Deployment of a trained model 134 by AI/ML module 214 may include serializing the trained model and deployment of the model via APIs. Monitoring and retraining of model 134 may include continuously monitoring model performance with respect to aspects such as data drift, and retraining and redeploying the model as necessary.

In the exemplary embodiment, look-up module 216 is a software module and configured to retrieve data such as certain user data (e.g., individual digital data 114) from database 206. In some embodiments, database 206 may store processed data such as data 218 in various data tables or other data structures within database 206 to facilitate querying and retrieval of such data. In some embodiments, look-up module 216 may be configured as a general look-up tool, capable of performing data look-ups in a variety of data tables or as the data is otherwise stored and provided in a database. In one non-limiting example, look-ups performed via look-up module 216 may be utilized in connection with re-training model 134 and/or deploying and applying a live version of model 134 to new CDM tasks.

In the exemplary embodiment, rules module 220 is a software module and configured to retrieve rules stored in database 206. The rules stored in database 206 may include various rules governing aspects computing system 102, including, but not limited to, response rules by model 134 when responding to emails on behalf of a user, data ingestion rules in connection with training/re-training models 134, data formatting rules, and the like.

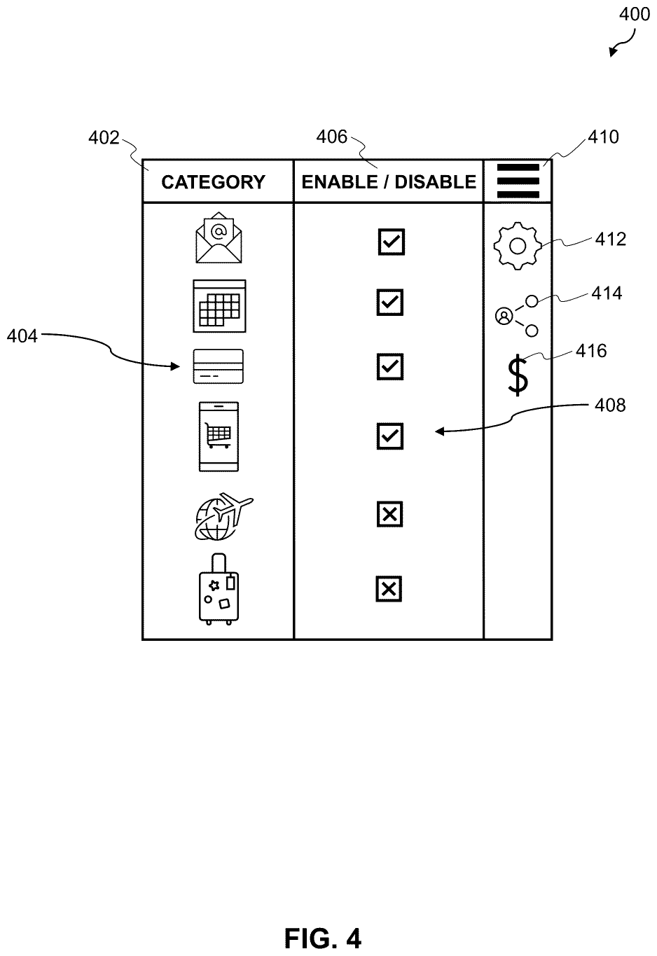

In some embodiments, rules may be derived from selections made by a user 104. For examples, rules in database 206 may be stored in conjunction with settings and/or preferences set or selected by a user 104 upon setting up platform 136 with their accounts 116-226, such as described in connection with FIG. 4. In some embodiments, look-up module 216 and rules module 220 may be used in conjunction with one another as part of initial model building functions of computing system 102 and/or for other subsequent aspects such as model re-training and the like, to ensure compliance with user settings as described in connection with FIG. 4, and/or for other purposes.

In the exemplary embodiment, output data 222 from platform 136 includes respective output data for each of accounts 116-126 that has been enabled for use with platform 136. Output data 222 may include instructions and/or other integration code to allow platform 136 to act on behalf of or as a user 104 would when using services associated with the accounts 116-126. Output data 222 may be referred to herein as a managed response from platform 136. The managed response may be generated in response to one or more events associated with the accounts 116-126, and function to resolve a condition associated with the event(s).

In the exemplary embodiment, platform 136 may be configured to generate user notifications 224. The subject matter of user notifications may vary based upon which account of accounts 116-126 the notification is utilized in connection with, as described below in more detail.

In some embodiments, output data 222 for email account 116 may entail causing the email account system to automatically respond to certain received emails with a response generated by model 134, and/or re-rank emails in an order of preference or priority that is based upon deeper contextual analysis and/or learned behaviors/patterns reflected in model 134 for the given user 104, as described below in more detail. In such cases, the received emails would classify as one example of an event associated with the email account, and an example of a condition resolved by the managed response would be at least one of responding to the emails or ranking the emails. In one non-limiting example, the email reply is generated in a style intended to not only reply, but to mimic the user via learned email response styles of the user and via text LLM-generated text from model 134.

In some embodiments, output data 222 for calendar account 118 may entail causing the calendar account system to automatically accept/deny/reschedule certain calendar invites, and/or add/remove invitees based upon deeper contextual analysis and/or learned behaviors/patterns reflected in model 134 for the given user 104, as described below in more detail. In such cases, the calendar invites would classify as one example of an event associated with the calendar account, and an example of a condition satisfied by the managed response includes updating the invite.

In one non-limiting example, this includes automatic day planning for user 104. In another example, this includes adding personal notifications via user notifications of when a user 104 should act in connection with a given task, scheduled event, etc. For example, a user notification 224 may be sent by platform 136 in the form of an alert notification alerting user 104 to leave extra early for a scheduled event due to construction on the route to the event.

Platform 136 may have determined to send such an alert notification based upon a traffic alert email received in the email inbox of user 104, or another source such as a news feed that user 104 is subscribed too. Accordingly, platform 136 may act beneficially on behalf of user 104 in a passive manner by “behind the scenes” monitoring of live developments such as traffic that may impact aspects such as travelling to a scheduled event, even when user 104 may have been unaware of the traffic issue.

In some embodiments, output data 222 for transportation account 120 may entail causing the transportation account system to automatically cancel, re-book, or change transportation bookings based upon deeper contextual analysis and/or learned behaviors/patterns reflected in model 134 for the given user 104, as described below in more detail. In such cases, an example of an event associated with the transportation accounts includes a change in transportation plans, and an example of a condition satisfied by the managed response includes updating a transportation plan.

In some embodiments, output data 222 for lodging account 122 may entail causing the lodging account system to automatically cancel, re-book, or change lodging bookings based upon deeper contextual analysis and/or learned behaviors/patterns reflected in model 134 for the given user 104, as described below in more detail. In such cases, an example of an event associated with the lodging accounts includes a change in lodging plans, and an example of a condition satisfied by the managed response includes updating a lodging plan.

In some embodiments, output data 222 for payment account 124 may entail automatically responding to OTP requests and/or other transaction approval requests (e.g., such as a text message approval request) sent by payment card providers to user 104 and associated with the user's transactions made via their payment cards. Platform 136 may act on behalf of user 104 to respond to the approval message based upon deeper contextual analysis and/or learned behaviors/patterns reflected in model 134 for the given user 104, as described below in more detail. In such cases, an example of an event associated with the payment accounts includes a transaction needing approval, and an example of a condition satisfied by the managed response includes providing approval of the transaction. Platform 136 may be integrated with native text messaging software on a user terminal such as a mobile phone, such that platform 136 can respond via text message to the approval message, for example in the case where the approval message was sent in the form of a text message to the user's mobile phone by the entity seeking approval of the transaction.

In some embodiments, output data 222 for payment account 126 may entail automatically responding to OTP requests and/or other transaction approval requests on behalf of user 104 based upon deeper contextual analysis and/or learned behaviors/patterns reflected in model 134 for the given user 104, as described below in more detail.

In some embodiments, integration module 210 and input module 212 are each configured integrally with platform 136. However, this is not limiting and these modules may be integral with other computing components of computing system 102 such as being integral with one or more computing devices 132 or external computing components operatively connected to computing system 102.

In some embodiments, AI/ML module 214 and look-up module 216 and input module 212 are each configured integrally with a computing device 132. However, this is not limiting and these modules may be integral with other computing components of computing system 102 or with external computing components operatively connected to computing system 102.

In some embodiments, platform 136 may also be configured to execute code in response to triggers such as changes in data, real-world events, and/or actions by users, and may be configured to be triggered by data stream services and can connect to storage systems or into workflows, effectively allowing for real-time decisioning and updating of a user's daily plans, which may include travel plans, etc.

In some embodiments, output data 222 may utilize formats compatible with the various accounts, including file formats such as CSV, PST, and OST, and code formats such as JSON.

In some embodiments, platform 136 may be integrated with the software of each of accounts 116-126 so that platform 136 may perform tasks within the software as user 104 would. For example, platform 136 may be configured to respond to an email in the manner a user would, respond to a text message in a manner that a user would, and so on and so forth, such that platform 136 can effectively mimic a user's actions with respect to the various accounts.

In some embodiments, model 134 may combine both personal and professional digital data 114. However, the model will be trained to be able to discern between personal and professional data. In one non-limiting example, a deployed version of model 134 may process calendar data of user 104 that includes dinner plans on consecutive nights. One dinner may be a personal dinner with friends, whereas the other dinner may be a business dinner with business associates. Based upon other contextual data such a personal and work emails and other learned aspects, model 134 will know that one dinner is personal while the other is professional. For example, because model 134 may also have access to email data of user 104, it will know from emails that the dinner on the first night is a dinner with friends and the dinner on the following night is with business associates, such as by comparing email addresses, names, dates/times, and other information contained within the respective personal and work emails to the date/time and/or other information contained in the calendar entries.

In some embodiments, platform 136, via model 134, may be configured to function as a concierge and/or assistant, such as a purchasing assistant. In one non-limiting example, a deployed version of model 134 may recognize that user 104 has been shopping for a large purchase such as a new car. Platform 136 may then automatically investigate current interest rates. Financing deals, dealer deals, and/or other offers and present such information to user 104 via a notification to user 104, such as described in connection with FIG. 2. Other examples include platform 136 prompting user 104 with notifications regarding staggering large purchases based upon income flow, including around timeframes such as tax time, or in connection with pay period schedules of an individual or head of households members (e.g., the primary earners of the household). Such concierge/assistant functionality may also include daily life planning tasks, and/or other periodic tasks such as home services including landscaping and the like. This may include platform 136 sending user 104 applicable seasonal reminders (e.g., pool/closing opening, etc.). Platform 136, serving “behind the scenes,” may allow users 104 to realize significant time savings by reducing the amount of calls, emails, and/or other communications that would normally be required for such frequently occurring daily life items.

In one comprehensive but non-limiting example that illustrates the scope and depth of the AI-based CDM for an individual user provided by platform 136, platform 136 may detect that user 104 was recently in the process of planning a business meeting/trip. Platform 136 may know this by virtue of analyzing recent emails and/or text messages of the user relating to planning of the business meeting/trip. For example, platform 136 may know that the parties agreed to meet on Monday, December 19^{th} at 10 am in Dallas based upon an agreement in a last email of an email chain relating to the setting up of the business meeting/trip. From this, platform 136 may then set out to find suitable flights for user 104, based upon what it has learned about user 104 either from initial intake of individual digital data 114 of user 104 and/or from preferences learned over time from user 104. Once a suitable flight is found, platform 136 may automatically book the flight based upon learned user travel behavior/patterns reflected in model 134, and in association with a transportation account 120 such as an airline account that has been linked to and integrated with platform 136.

However, while in the air flying to Dallas, the pilot announces that the plane will now be arriving early, as reflected in the arrival/departure scheduling systems of the airline. Because platform 136 is linked to and integrated with the airline account (e.g., as one of the transportation accounts 120 of user 104), platform 136 will receive notice of the early landing information and can then act upon the early landing. This may include platform 136 automatically scheduling a rideshare pickup from a rideshare account of user 104 linked to and integrated with platform 136 as another transportation account 120 of user 104. The scheduled rideshare pickup may be set based upon the revised early landing time of the plane that platform 136 has knowledge of, so that the rideshare is available shortly after the plane of user 104 lands. This may include platform 136 automatically approving the rideshare transaction on behalf of user 104 based, for example, on a payment account such as account 124 or 126 that has been linked to and integrated with platform 136, and/or permissions granted by user 104 for such approval. Notably, all of these steps can be performed by platform 136 while user 104 is still in the air and at a time when user 104 may not have the ability to use their mobile device 110 to set up the rideshare in view of the early arrival.

Later on, during the business trip, user 104 hosts a business dinner. Platform 136 is aware of the user's location and a calendar invite that corresponds to the location/date/time of the business dinner, and automatically approves the corresponding payment card transaction paying for the business dinner based, for example, on the geolocation (e.g., via geolocation data 130) of the user, the prior-known calendar entry matching the dinner time/date/location, and in view of the transaction approval authority granted to platform 136 by user 104 in connection with payment accounts 124, 126. Then, at the end of the business trip, platform 136 automatically completes checkout from the hotel that user 104 stayed at during the business trip and that is associated with a lodging account 122 linked to and integrated with platform 136, and automatically schedules another rideshare from the hotel to the airport and/or from the airport to home upon the landing of the user's plane. Platform 136 is therefore particularly useful and convenient for users in scenarios where/when users may be unavailable to manually schedule or adjust their plans, such as while mid-flight in a plane without data access.

The level and extent of integration of platform 136 with a plurality of user accounts (e.g., accounts 116-126), coupled with the ability to dynamically adjust plans to adjust to late-breaking events such as traffic delays, early plane landings, etc., all the while alerting the user to such changes and via use of a highly individualized model, represents a significant improvement over conventional techniques and technologies. CDM system 100 and platform 136 thereof reduce the amount of digital messages that need to be sent, which in turn reduces unnecessary use of computing and human resources and network traffic/congestion. Additionally, by being linked to airline accounts of user 104, platform 136 will know whether the user has checked baggage or only used a carry on, and can adjust scheduling of rideshares according, such as to account for time needed to reclaim checked baggage.

In one comprehensive but non-limiting example that illustrates the scope and depth of the AI-based CDM for a group of users provided by platform 136, a husband and a wife may share a common payment account such as a common payment card in the form of a payment card associated with a shared payment account 126. The couple may have set up a household account within platform 136 thereby granting access to platform 136 various accounts of both the husband and the wife, including their respective email and calendar accounts 116 and 118, and their respective travel-related accounts such as accounts 120 and 122. Platform 136 may, during the course of normal operation in connection with managing the household account of the husband and wife, detect that each will be going on a separate business trip in different locations (e.g., New York and Chicago) at the same time. In conventional systems, when each of the husband and wife makes a purchase using the common payment card in different cities, a fraud alert is likely to be generated due to the “same” card being used in two different locations that are geographically far from one another, and the transaction may be declined or delayed pending confirmation that the purchases were not fraudulent, which may require an affirmative action to be taken by the card holders.

However, platform 136 will know from each of the husband and wife emails, calendars, and their respective geolocation data that each transaction is likely to be bona fide because the usage of the payment card in the respective city (e.g., New York and Chicago) coincides with other information gleaned or deciphered by platform 136. As such, platform 136 is able to approve the transactions without intervention by either of the husband or wife, such as by responding to any fraud alerts sent by the payment card issuer to, for examples, mobile communication devices (e.g., 110) of each of the husband and wife. This represents a great convenience to users and an improvement over conventional techniques in the field. CDM system 100 and platform 136 thereof reduces the amount of digital messages that need to be sent, which in turn reduces unnecessary use of computing and human resources and network traffic/congestion. For example, by virtue of platform 136 knowing that usage of the same shared payment account in two cities was bona fide, a human fraud agent of the payment card provider may not need to be utilized.

### Exemplary Model Training And Deployment

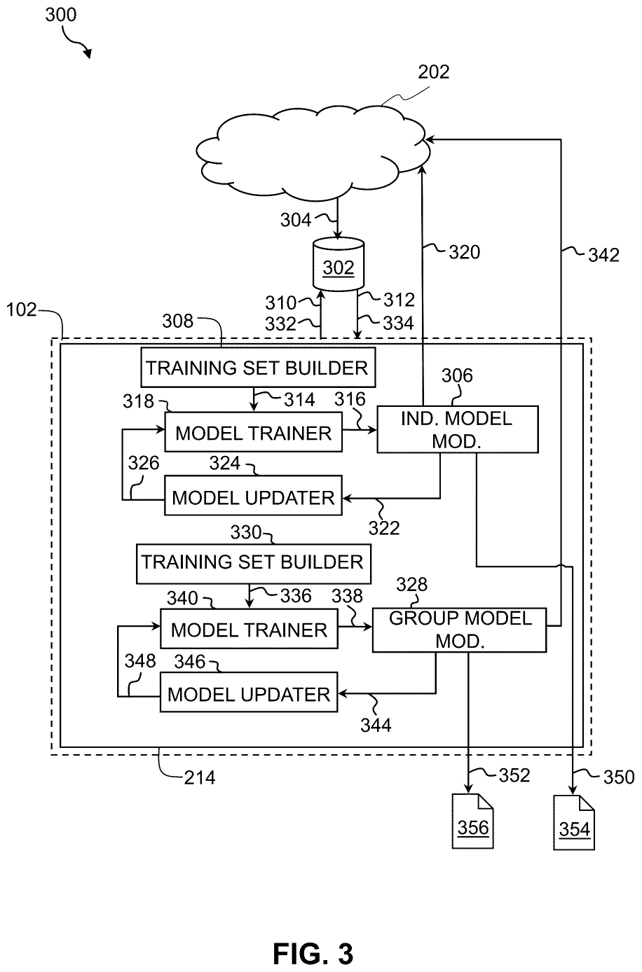

FIG. 3 is a schematic diagram 300 illustrating the training of models via AI/ML module 214, which may be implemented and executed by/within computing system 102 (each shown in FIG. 2).

In the various model training and deployment embodiments described below, “ML” refers broadly to various algorithms that may be used to train the model to identify and recognize patterns in existing data in order to facilitate making predictions for subsequent new input data. In some embodiments, models 134 may include one or more ML models that may include one or more neural networks, such as a convolutional neural network, a deep learning neural network, or the like. The neural network may have one or more layers of nodes, and the model parameters adjusted during training may be respective weight values applied to one or more inputs to each node to produce a node output.

In other words, the nodes in each layer may receive one or more inputs and apply a weight to each input to generate a node output. The node inputs to the first layer may correspond to the model input data fields, and the node outputs of the final layer may correspond to the at least one output of the model, intended to predict the at least one result data field. One or more intermediate layers of nodes may be connected between the nodes of the first layer and the nodes of the final layer.

In the exemplary embodiment, computing system 102 may be configured to communicate via network 202 with other components shown in diagram 200 such as server 208 and database 206. Computing system 102 may additionally include and/or be in communication with one or more databases 302 that stores data 304 including individual digital data 114, which includes transaction data 128. Data 304 received from network 202 may be stored in database 302.

Computing system 102 may be configured to use data 304 to generate an individual model module 306 for generating and providing an individual model in the form of one or more of models 134, for controlling operations of the computing system 102 and platform 136 relating to learning user behavior and preferences in connection with accounts 116-126 of the user, generating action recommendations in response to operational requests, and the like. For example, individual digital data 114 and/or data 218 of a given user 104 may be stored in database 302 and used by ML individual model module 306 to train an individual model. Individual digital data 114 and/or data 218 may include data spanning a certain period of time, which may, in some embodiments, be selectable by a user upon setup of platform 136 with one or more of their accounts 116-126, as described in more detail below in connection with FIG. 4.

In the exemplary embodiment, computing system 102 includes a training set builder module 308 configured to submit one or more queries 310 to database 302 to retrieve subsets 312 of data 304, and to use those subsets 312 to build training data sets 314 for generating the individual model via individual model module 306. For example, query 310 may be configured to retrieve certain fields from data 304 for historical data sharing characteristics, transactions originated by certain POS or merchants, transaction history for an account holder, historical emails, calendar invites, schedules, travel plans (e.g., airplanes, rideshare usage), hotel stays, and the like. In some embodiments, data 304 may be formatted and/or stored in database 302 as described herein in connection with database 206.

In the exemplary embodiment, training set builder module 308 may be configured to derive training data sets 314 from retrieved subsets 312. Each training data set 314 may corresponds to historical data from data 304 (“historical” in this context means completed in the past, as opposed to completed in real-time with respect to the time of retrieval by training set builder module 308). Each training data set 314 may include “model input” data fields along with at least one “result” data field representing a historical outcome associated with the model input. The model input data fields represent factors that may be expected to, or unexpectedly be found during model training to, have some correlation.

To facilitate learning, computing system 102 includes one or more databases 302 at which the data (e.g., data 114 and/or 218), including requests, responses, feature parameter codes, evidence, outcomes, etc., is stored. This data may become one or more input training sets used by the training set builder module 308. Model outputs may be formatted for presentation or review as visual representations of recommendations, as text-based or natural language recommendations, and the like.

In the exemplary embodiment, the model input data fields in training data sets 314 may be generated from data fields in subset 312 corresponding to historical data of data 304. In other words, a trained machine learning model 316 produced by a model trainer module 318 for use by individual model module 306 may be trained to make predictions based upon input values that can be generated from the data fields in data 304. Values in the model input data fields may include values copied directly from values in a corresponding data field in the retrieved subset 312, and/or values generated by modifying, combining, or otherwise operating upon values in one or more data fields in the retrieved subset 312. The use of such data fields as model input data fields facilitates the machine learning model in weighing these factors directly. After training set builder module 308 generates training data sets 314, training set builder module 308 passes the training data sets 314 to model trainer module 318.

In the exemplary embodiment, model trainer module 318 may be configured to apply the model input data fields of each training data set 314 as inputs to one or more machine learning models such as one or more models 134 for one or more users 104. Model trainer module 318 is configured to compare, for each training data set 314, the at least one output of the model to the at least one result data field of the training data set 314, and apply an ML algorithm to adjust parameters of the model in order to reduce the difference or “error” between the at least one output and the corresponding at least one result data field.

In this way, model trainer module 318 trains the machine learning model to accurately predict the value of the at least one result data field. In other words, model trainer module 318 cycles the one or more machine learning models through the training data sets 314, causing adjustments in the model parameters, until the error between the at least one output and the at least one result data field falls below a suitable stability threshold, and then uploads at least one trained machine learning model 316 to individual model module 306 for application in generating recommendations 320. In the exemplary embodiment, model trainer module 318 is configured to simultaneously train multiple candidate ML models and to select the best performing candidate for each result data field, as measured by the “error” between the at least one output and the corresponding result data field, to upload to individual model module 306.

In some embodiments, as model trainer module 318 cycles through the training data sets 314, model trainer module 318 applies a suitable backpropagation algorithm to adjust the weights in each node layer to minimize the error between the at least one output and the corresponding result data field. In this fashion, the ML model may be trained to produce an output that reliably predicts the corresponding result data field. Alternatively, the ML model may have any suitable structure.

In some embodiments, model trainer module 318 provides an advantage by automatically discovering and properly weighting complex, second-or third-order, and/or otherwise nonlinear interconnections between the model input data fields and the at least one output. Absent the ML model, such connections are unexpected and/or undiscoverable by human analysts.

In the exemplary embodiment, individual model module 306 compares feedback, and routes a comparison result 322 generated by comparing recommendation 320 to the feedback to a model updater module 324 of the computing system 102. Model updater module 324 is configured to derive a correction signal 326 from comparison results 322 received for one or more recommendations and to provide correction signal 326 to model trainer module 318 to enable updating or “re-training” of the at least one ML model to improve performance. The re-trained at least one machine learning model 316 may be periodically re-uploaded to individual model module 306, and the re-trained model be used to generate an updated model 134 output via output 350.

In the exemplary embodiment, computing system 102 is also configured to use data 304 to generate and/or be used in association with group model module 328 for generating and providing a group model, for controlling group data analysis operations of computing system 102, detecting group behaviors and preferences in connection with aspects of one or more of accounts 116-126 of each user 104 included within the group (e.g., included within a given group profile 144), generating action recommendations in response to operational requests, and the like.

In the exemplary embodiment, computing system 102 includes a training set builder module 330 that is configured to submit one or more queries 332 to database 302 to retrieve subsets 334 of data 304, and to use those subsets 334 to build training data sets 336 for generating a group model via group model module 328. For example, query 332 is configured to retrieve certain fields from data 304 for historical data including past transactions and characteristics of such, email writing tone/formats, travel habits, and the like, in association with group usage of one or more of accounts 116-126.

In the exemplary embodiment, training set builder module 330 may be configured to derive training data sets 336 from retrieved subsets 334. Each training data set 336 corresponds to a historical data 304 (“historical” in this context means completed in the past, as opposed to completed in real-time with respect to the time of retrieval by training set builder module 330, and may also correspond to information within output 350 from individual model module 306, where the output 350 from individual model module 306 provides training set builder module 330 with the latest scoring parameters of the group model so that the training set builder module 330 can more accurately train the model to learn about the group).

In the exemplary embodiment, the model input data fields in training data sets 336 may be generated from data fields in subset 334 corresponding to historical data 304. In other words, a trained machine learning model 338 produced by a model trainer module 340 for use by group model module 328 may be trained to make predictions based upon input values that can be generated from the data fields in data 304. Values in the model input data fields may include values copied directly from values in a corresponding data field in the retrieved subset 334, and/or values generated by modifying, combining, or otherwise operating upon values in one or more data fields in the retrieved subset 334. The use of such data fields as model input data fields facilitates the ML model in weighing these factors directly.

After training set builder module 330 generates training data sets 336, training set builder module 330 passes the training data sets 336 to model trainer module 340. In some embodiments, model trainer module 340 may be configured to apply the model input data fields of each training data set 336 as inputs to one or more machine learning models, such as group model module 328. Each of the one or more machine learning models may be programmed to produce, for each training data set 336, at least one output intended to correspond to, or “predict,” a value of the at least one result data field of the training data set 336. As described above, to facilitate learning, computing system 102 may be configured to include one or more databases 302 at which the data, including requests, responses, feature parameter codes, evidence, outcomes, etc., is stored. This data becomes one or more input training sets used by the training set builder module 330.

Model trainer module 340 may be configured to compare, for each training data set 336, the at least one output of the model to the at least one result data field of the training data set 336, and apply a machine learning algorithm to adjust parameters of the model in order to reduce the difference or “error” between the at least one output and the corresponding at least one result data field. In this way, model trainer module 340 trains the machine learning model to accurately predict the value of the at least one result data field. In other words, model trainer module 340 cycles the one or more machine learning models through the training data sets 336, causing adjustments in the model parameters, until the error between the at least one output and the at least one result data field falls below a suitable stability threshold, and then uploads at least one trained machine learning model 338 to group model module 328 for application in generating recommendations 342.

In the exemplary embodiment, model trainer module 340 may be configured to simultaneously train multiple candidate ML models and to select the best performing candidate for each result data field, as measured by the “error” between the at least one output and the corresponding result data field, to upload to group model module 328 for outputting a deployable group model 134.

In the exemplary embodiment, as model trainer module 340 cycles through the training data sets 336, model trainer module 340 applies a suitable backpropagation algorithm to adjust the weights in each node layer to minimize the error between the at least one output and the corresponding result data field. In this fashion, the ML model may be trained to produce output that reliably predicts the corresponding result data field. Alternatively, the ML model may have any suitable structure.

In some embodiments, model trainer module 340 may provide an advantage by automatically discovering and properly weighting complex, second-or third-order, and/or otherwise nonlinear interconnections between the model input data fields and the at least one output. Absent the ML model, such connections are unexpected and/or undiscoverable by human analysts.

In the exemplary embodiment, group model module 328 compares feedback, and routes a comparison result 344 generated by comparing recommendation to the feedback to a model updater module 346 of the computing system 102. Model updater module 346 is configured to derive a correction signal 348 from comparison results 344 received for one or more recommendations and to provide correction signal 348 to model trainer module 340 to enable updating or “re-training” of the at least one machine learning model to improve performance. The retrained at least one machine learning model 338 may be periodically re-uploaded to group model module 328 which may be used to generate an updated deployable group model 134. Individual model module 306 and group model module 328 may be referred to individually as separate ML modules, or as being within a single ML module (e.g., the single ML module includes both the individual model module and the group model module).

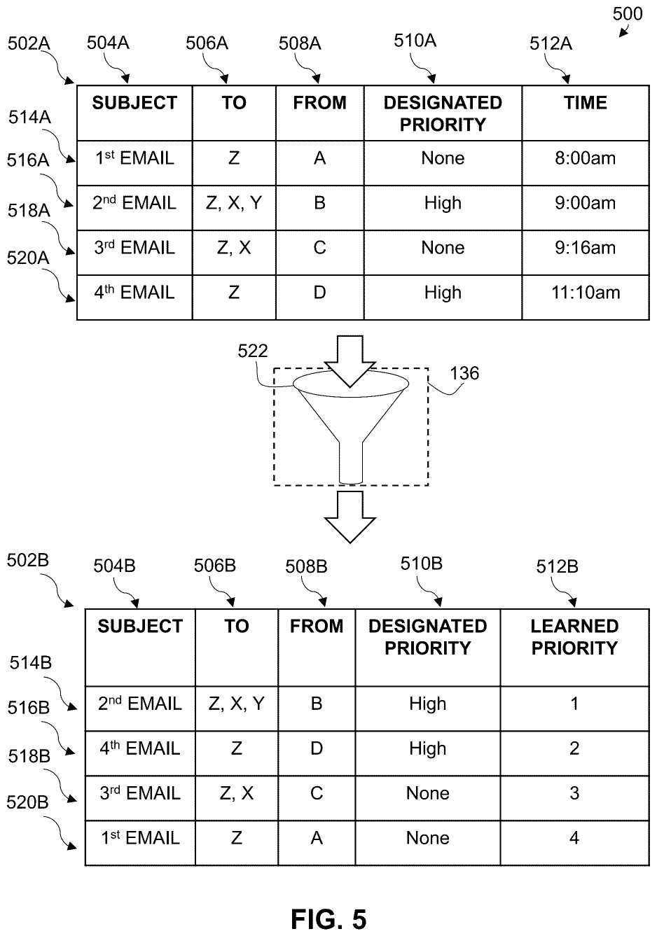

In some embodiments, output 350 of individual model module 306 may include, for example, the latest parameters of the latest individual model, and output 352 of group model module 328 may include, for example, the latest parameters of the latest group model. These parameters may include but are not limited to a feature parameter set containing feature parameters that have been determined to have a desired correlation with a user's behavior and preferences with respect to transactions, travels, email writing tone and style, and other aspects relating to how a user utilizes one or more of accounts 116-126. As described in more detail in connection with FIGS. 4 and 5, a feature parameter set of a model may include a finite amount of feature parameters that have, through various analysis, been determined to correlate with user behavior and/or preferences. In some embodiments, there may be dozens of feature parameters with a feature parameter set. However, this amount is not static, and may change over time as new patterns and/or new intelligence/insight is gained.

In some embodiments, output 350 may be configured as or include an executable file 354 for executing the individual model as a model 134, and output 352 may be configured as or include an executable file 356 for executing the group model as a model 134. The executable files may contain the latest versions of the respective models, and may be executed by a computing device such as user computing device 224 to run the models against defined data sets, such as transaction data of known transactions. For example, the individual model and the group model may be run in an offline environment with a known data set as an input to determine the accuracy of the models and to determine which feature parameters of the models correlate most strongly with user behaviors and preferences. In some embodiments, files 354 and 356 may be implemented as one or more of file 138 shown in FIG. 1.

In some embodiments, each model 134 may be configured as an LLM-based model capable of reading and understanding text and responding in text. Model 134 may be configured to extract data (e.g., a meaning of a message) and generate a response (e.g., a reply to the message or a request for more information) based upon the extracted data. The responses may also be guided by rules stored in response database 206 as accessed by rules module 220 (each shown in FIG. 2), either by method of Retrieval-Augmented Generation (RAG) from look-up module 216 or rules module 220 to supplement the prompts to the LLM or training and retraining model 134.

In some embodiments, database 302 may be part of, integral with, or otherwise operatively connected to database 206 and accessible via server 208 (each shown in FIG. 2). In other embodiments, database 302 may be a stand-alone database associated with computing system 102 or otherwise provided within the system shown in diagram 200 and accessible by computing system 102. It should be understood that the various databases described herein can be configured integrated with or separate from one another, either locally or via a network (e.g., cloud).

In some embodiments, individual models generated by individual model module 306 may include each of a personal user model and a professional individual model, where the personal individual model may only reflect aspects of a user's personal (e.g., non-work) life, and the professional model may only reflect aspects of a user professional (e.g., work) life. However, a model 134 output from individual model module 306 may combine both personal and professional data as part of a combined model that takes into account both personal and professional life aspects. Each of the one or more machine learning models is programmed to produce, for each training data set 314, at least one output intended to correspond to, or “predict,” a value of the at least one result data field of the training data set 314.

In some embodiments, each of the individual model and the group model may be configured to serve as an input to the other model, where an output (e.g., output 352) from group model module 328 may be fed into individual model module 306 (e.g., via training set builder module 308) so that individual model module 306 can be updated against the latest parameters of group model module 328, or vice versa. This may, for example, be utilized to improve upon the individual aspects of individual models 134 and the group aspects of group models 134 by training the other model what parameters or features correlate strongly to individual versus group behaviors and preferences. Each training data set 314/336 may include “model input” data fields along with at least one “result” data field representing a historical outcome associated with the model input. The model input data fields represent factors that may be expected to, or unexpectedly be found during model training to, have some correlation.

Put another way, individual model module 306 and group model module 328 may have a working (e.g., symbiotic) relationship where individual model module 306 feeds training set builder module 330 of group model module 328 and/or vice versa so that each model learns and grows over time to better determine, predict, and user/group behavior and preferences. Model outputs can be formatted for presentation or review as visual representations of recommendations, as text-based or natural language recommendations, and the like.

### Exemplary User Interface

FIG. 4 illustrates an exemplary user interface 400 provided by platform 136 as shown in FIG. 1, in accordance with the present disclosure. In the exemplary embodiment, user interface 400 may be executed for display on displays of one or more of electronic devices 106-112 shown in FIG. 1 and for a user 104 to interact with in connection with linking to and integrating one or more of accounts 116-126 with platform 136.

In the exemplary embodiment, user interface 400 may present visual graphics to user 104 and the option to select which types of individual digital data 114 to use with platform 136 for purposes of permitting platform 136 to ingest corresponding individual digital data 114 for use by model 134, and to use a deployed version of model 134 in approving transactions and/or managing emails, calendars, reservations, etc., as described herein.

In the exemplary embodiments, user interface 400 may include one or more columns or other arrangements to organize on-screen information for presentation to a user 104. This may include a “Category” column 402 including a plurality of icons 404 corresponding to the various individual digital data types (e.g., for email account 116, calendar account 118, transportation account 120, lodging account 122, and payment accounts 124, 126) that platform 136 is capable of managing. User interface 400 may include an “Enable/Disable” column 406 including a plurality of selectable buttons 408 to select which of the enumerated categories to enable/disable with respect to platform 136 having access. User interface 400 may also include a “Menu” column 410 including a plurality of menu items such as general settings 412, share settings 414, payment settings 416, and other settings (not shown) that enable users to select specific settings related to linking and integrating platform 136 with one or more of accounts 116-126, setting up individual and/or group accounts, and the like.

In some embodiments, general settings 412 may include providing a user with a choice as to a duration of time in which platform 136 should look back for retrieving data (e.g., digital data 114) for any accounts of accounts 116-126 linked to and integrated with platform 136. In one non-limiting example, this may include a user designating that platform 136 should only include emails from 5 years ago or sooner, or transactions from within the last year. This gives users a chance to tailor their model 134 to not include very old data that is not desirable for the model to consider, and may be accomplished by visual graphics such a timeline sliders or simply entering a number into fields corresponding to time ranges (e.g., “Maximum Years to Look Back: 5”).

Payment settings 416 may display linked payment accounts, and the user interface may provide user 104 with the ability to set spending thresholds/limits for the various account, and to set aspects relating to other payment and/or transaction approval aspects. For example, user 104 may, via payment settings 416, permit platform 136 to automatically approve any transactions with an amount under a certain limit (e.g., $100), such that platform 136 may then respond to any transaction approval requests and/or other related communications on behalf of user 104.

Relatedly, any transaction approval request for a transaction amount that is over the limit set by user 104 may either (i) not be processed by platform 136 and be sent directly to user 104 via text message/email message in accordance with existing communication settings established by user 104 with the payment card provider, or (ii) still be processed by platform 136 for other purposes such as data ingestion purposes but not for purposes of platform 136 automatically responding on behalf of user 104.

In some embodiments, general settings 412 may additionally or alternatively include a user-selectable option to create separate personal and professional (e.g., work) models, or blended models that include all aspects (e.g., personal and professional) of a user's (e.g., digital) life. Similarly, general settings 412 may allow a user to select aspects of group models, such as the members of a household for a personal group model and/or which employees to include within a professional (e.g., work) group profile, that may include members of a particular department or work unit.

In some embodiments, user-selected settings in settings 412 may be stored as rules in database 206 and accessed via rules module 220 (each shown in FIG. 2) for purposes such as those described herein.

The above description is a simplified description of a user interface 400 that may be used with the systems and methods described herein. However, the user interface 400 may include less or more functionality as needed.

### Exemplary Ranking

FIG. 5 is a diagram 500 illustrating a process of ranking emails by preference or priority according to the present disclosure. In the exemplary embodiment, model 134 may be configured as an individual model wherein user 104 has enabled platform 136 to link to and integrate with their email account 116 to assign more meaningful levels of priority to emails based upon learned priority factors and/or other aspects of the emails. Table 502A illustrates a listing of emails based upon time of receipt, which is the order in which many conventional email services list emails. Table 502A includes a “Subject” column 504A, a “TO” column 506A, a “FROM” column 508A, a “DESIGNATED PRIORITY” email services, and a “TIME” column 512A. Rows 514A-520A list the various first through fourth emails shown in the list. The first email in row 514A was sent to “Z” from “A” at 8:00 am and was not indicated as having any priority. The second email in row 516A was sent to “Z,” “X,”, and “Y” from “B” at 9:00 am with a “HIGH” level of priority. The third email in row 518A was sent to “Z” and “X” from “C” at 9:16 am with no designated priority. The fourth email in row 520A was sent to “Z” from “D” at 11:10 am with a “HIGH” level of priority. For purposes of this example, user 104 is user “Z”. It is not immediately apparent which of the first to fourth emails is the most urgent or in need of the most attention, as two emails were sent with “HIGH” priority but by different senders and to different recipients.

In the exemplary embodiment, platform 136 may analyze the emails listed in rows 514A-520A such that a model 134 is applied to the emails. This is represented in FIG. 5 by funnel process 522. Funnel process 522 is indicative of platform 136 evaluating the emails via model 134 by analyzing the text in each of columns 504-512 and taking into account other factors to make a determination as to the priority of each email listed in rows 514A-520A.

In the exemplary embodiment, the output from platform 136 may re-order the emails in a new order ranked on priority as contextually determined by platform 136 via funnel process 522 which includes aspects learned by way of platform 136 having access to user 104's email account 116, having learned on past emails. Table 502B is generally similar to table 502A but replaces the “TIME” column in table 502A with a “LEARNED PRIORITY” column. Table 502B may include a “Subject” column 504B, a “TO” column 506B, a “FROM” column 508B, a “DESIGNATED PRIORITY” column 510B which may be indicative of a priority flag or starring in conventional email services, and a “LEARNED PRIORITY” column 512B reflecting the result of funnel process 522. Rows 514B-520B list the various emails in an order that is based upon priority as determined by learned factors via platform 136.

The email in first row 514B is the prior second email that was sent to “Z,” “X,”, and “Y” from “B” at 9:00 am with a “HIGH” level of priority. The email is second row 516B is the prior fourth email that was sent to “Z” from “D” at 11:10 am with a “HIGH” level of priority. The email in third row 518B is the prior third email that was sent to “Z” and “X” from “C” at 9:16 am with no designated priority. The email in the fourth row 520B is the prior first email that was sent from “Z” from “A” at 8:00 am and was not indicated as having any priority.

Here, platform 136 learned from prior emails of user 104 (aka recipient “Z”) that sender “B” is a notable sender (e.g., an important sender such as C-suite personnel) and that recipient “Y” being included in the recipient chain is also a notable aspect. As such, funnel process 522 weighted the prior second email with the highest priority of the four emails. Similar considerations were made for the prior first, third and fourth emails to arrive at the order of emails listed in table 502B. Other factors that may contribute to such a ranking include the evaluation of text in the subject line and/or the body of the email, other emails in the email chain, if any, the designated priority, and so on and so forth. For example, platform 136 may detect that an email from within the same email chain but from 3 days prior includes a due date listed therein that applies to the most recent email.

This may cause such an email to rise in level of priority as platform 136 has detected that the email involves a due date. Funnel process 522 may determine the overall weight based upon weighting parameters and other learned factors specific to recipient “Z.” As such, by way of platform 136, recipient “Z” may be able to receive a notification such as notification 224 and/or see a re-organized ranking in the email program associated with their email account 116. Thus, recipient “Z” does not have to wonder if the emails marked as “HIGH” priority were accurately marked and are deserving of immediate attention, or if an email without such a designation is actually the most pressing email that needs immediate attention. Platform 136 may determine the most pressing emails for recipient Z so that recipient Z may be able to attend to emails that need immediate and/or extra attention.

### Exemplary Computer-Implemented Method

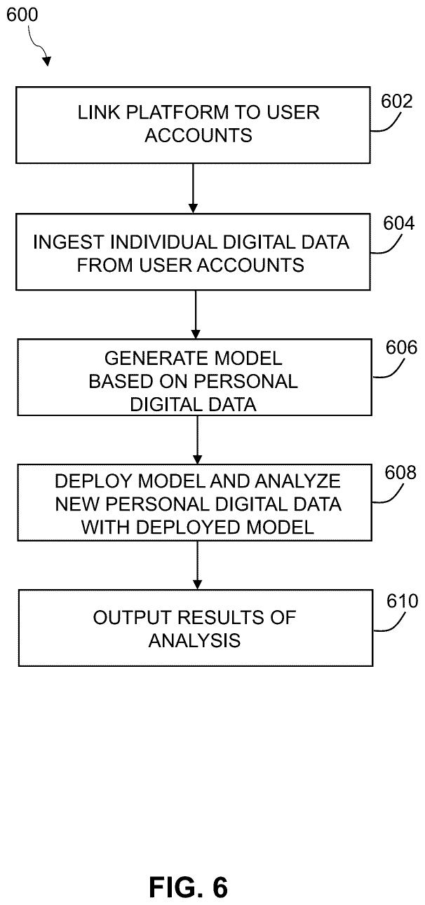

FIG. 6 illustrates a flow chart of an exemplary computer-implemented method 600 implemented by the CDM system 100 (shown in FIG. 1). In the exemplary embodiment, method 600 may be implemented by computing system 102 of CDM system 100.

In the exemplary embodiment, method 600 may include linking 602 platform 136 to user accounts such as accounts 116-126. This may include a user 104 downloading or installing software associated with platform 136 to one or more of electronic devices 106-112, and navigating user interface 400 shown in FIG. 4 to set up linkages to the desired user accounts, including selection of other settings such as data time frames, sharing settings, and the like.

In the exemplary embodiment, method 600 may further include ingesting 604 individual digital data 114 from each of the accounts 116-126 that were linked to platform 136. This may include ingesting data spanning a certain timeframe based upon settings selected by user 104.

In the exemplary embodiment, method 600 may further include generating 606 one or more models 134 based upon the ingested individual digital data 114. This may include performing the steps described in connection with FIG. 3. The one or more models 134 may be trained using the ingested data 114 including historical digital data from the accounts. The historical data may be used to train the models along with other profile data of the user to output predictions for responding to or addressing current data 114 ingested into the model. The current data may include a current email, for example, that the model analyzes based on its training, and then outputs a response for managing or responding to the email without any further input from the user.

In the exemplary embodiment, method 600 may further include deploying 608 a live version of model 134 to operate on and analyze new individual digital data of accounts from amongst accounts 116-126 that were linked by user 104 to platform 136, and as described in connection with FIG. 5, for example.

In the exemplary embodiment, method 600 may further include outputting 610 results of analysis of new individual digital data 114 by the deployed live model. Output results may vary for each type of account 116-126. For email account 116, the output result may be automatically preparing a response to an email, generated via language generation features of model 134, and/or email priority ranking such as described in connection with FIG. 5. For calendar accounts 118, the output result may be updating a date/time and/or attendees of a calendar invite. For transportation accounts 120, the output result may include automatically booking a flight based upon information gleaned by platform 136 from emails and/or calendar invites. For lodging accounts 122, the output result may include platform 136 automatically checking into or out of a hotel based upon information gleaned by platform 136 from emails and/or calendar invites.

For payment accounts 124, 126, the output result may include automatically responding to an approval request sent by a payment card provider to approve a transaction, such as by inputting a OTP to approve a transaction. For example, platform 136 may read the OTP sent in an email to the user's email and automatically input the OTP in a necessary field to complete a transaction.

In some embodiments, the output result may be a combination of output results associated with of various user accounts. For example, platform 136 may need to reference data from a user's email and/or calendar to be able to automatically approve a transaction while also relying on geolocation data such as data 130 as part of the automated approval criteria.

In some embodiments, settings 412 shown in FIG. 4 may provide for a user 104 to set how many factors need to be present in order for platform 136 to have transaction approval authority. User 104 may define that platform 136 only needs geolocation data and one or more of corresponding indicator from the user's email or calendar. As such, if user 104 uses their payment card while on a business trip in New York, and platform 136 knows that the user's calendar indicated that the user would be in New York at the same time the transaction was made, platform 136 would be permitted to approve the transaction on behalf of the user based upon the calendar entry and a geolocation of the user's electronic device 110 being confirmed as New York.

### Exemplary Computer System

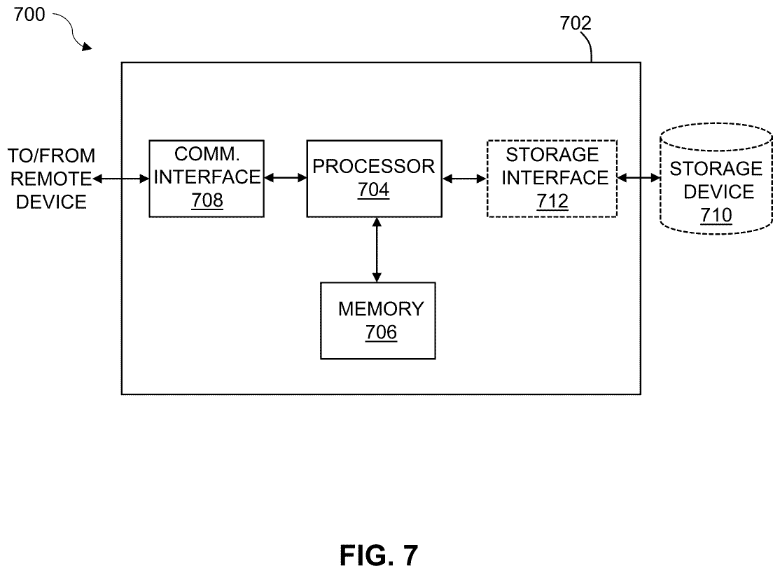

FIG. 7 illustrates block diagrams of an embodiment of an exemplary computer system or cloud server in which the present CDM processes may be implemented. It should be appreciated that FIG. 7 provides only an illustration of one implementation and does not imply any limitations with regards to the environments in which different embodiments may be implemented. Many modifications to the depicted environments may be made based upon design and implementation requirements.

FIG. 7 illustrates an exemplary configuration 700 of a data processing system 702 that is representative of any electronic device capable of executing machine-readable program instructions. Examples of such electronic devices include computing systems, environments, and/or configurations that may be represented by data processing system 702 and include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices. For example, any of the servers described herein (e.g., servers 204, 208) may be configured as a data processing system 702. Computing system 102, and any sub-systems thereof or other computing systems or devices such as computing devices 132 associated therewith may also be configured as a data processing system 702. In some embodiments, a provider of CDM system 100 may include one or more data processing systems 702 as part of analyzing models 134, where an employee or related entity of the provider of CDM system 100 may use a data processing system 702 to view outputs of models 134 and/or otherwise interact with models 134 via data processing system 702.

In the exemplary embodiment, data processing system 702 may include a processor 704 for executing instructions. Instructions may be stored in a memory area 706. Processor 704 may include one or more processing units (e.g., in a multi-core or parallel processing configuration). Processor 704 may be operatively coupled to a communication interface 708 such that data processing system 702 is capable of communicating with a remote computing device. For example, data processing system 702 may receive messages and/or events from outside systems via the Internet and/or over locally networked computers and/or cellular network.

In the exemplary embodiment, processor 704 may also be operatively coupled to a storage device 710 (e.g., which may be implemented as any of databases 204, 206, each shown in FIG. 2, and/or database 302 shown in FIG. 3). Storage device 710 may be any computer-operated hardware suitable for storing and/or retrieving data. In some embodiments, storage device 710 may be external to data processing system 702 and may be accessed by a plurality of data processing systems 702. For example, storage device 710 may include a storage area network (SAN), a network attached storage (NAS) system, and/or multiple storage units such as hard disks and/or solid-state disks in a redundant array of inexpensive disks (RAID) configuration.

In other embodiments, storage device 710 may be integrated in data processing system 702. For example, data processing system 702 may include one or more hard disk drives as storage device 710. Data such as data 114 and/or utilized in conjunction with CDM system 100 may be stored in a storage device 710 within CDM system 100, and/or stored across various other databases operatively connected to computing system 102.

In some embodiments, processor 704 may be operatively coupled to storage device 710 via a storage interface 712. Storage interface 712 may be any component capable of providing processor 704 with access to storage device 710. Storage interface 712 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 704 with access to storage device 710.

### Exemplary User Terminal

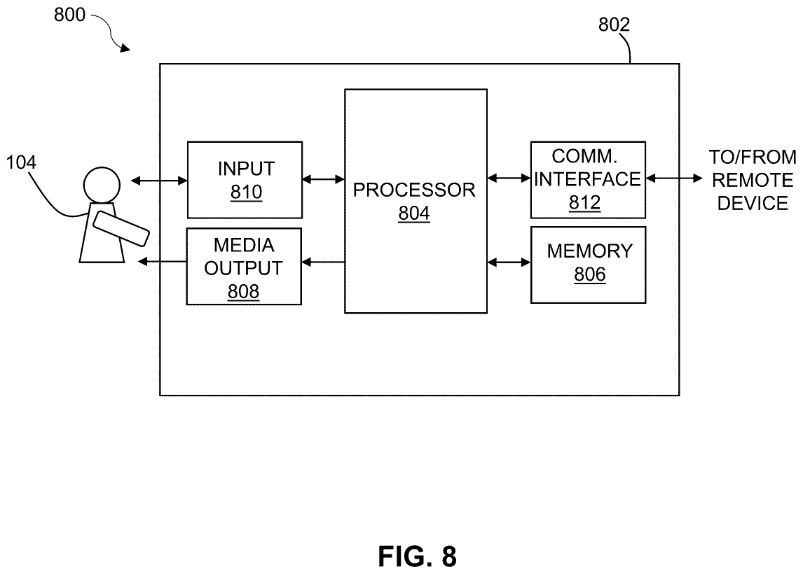

FIG. 8 illustrates a block diagram of an embodiment of a user terminal or user device in which the present CDM processes may be implemented. It should be appreciated that FIG. 8 provides only an illustration of one implementation and does not imply any limitations with regards to the environments in which different embodiments may be implemented. Many modifications to the depicted environments may be made based upon design and implementation requirements.

FIG. 8 depicts an exemplary configuration 800 of a user terminal 802 and which may be configured as a user computer device, in accordance with one embodiment of the present disclosure. In the exemplary embodiment, user terminal 802 may be similar to, or the same as, electronics devices 106-112 (shown in FIG. 1). User terminal 802 may be operated by a user 104.

User terminal 802 may include a processor 804 for executing instructions. In some embodiments, executable instructions may be stored in a memory area 806. Processor 804 may include one or more processing units (e.g., in a multi-core or parallel processing configuration). Memory area 806 may be any device allowing information such as executable instructions and/or transaction data to be stored and retrieved. Memory area 806 may include one or more computer readable media.

User terminal 802 may also include at least one media output component 808 for presenting information to user 104. Media output component 808 may be any component capable of conveying information to user 104. In some embodiments, media output component 808 may include an output adapter (not shown) such as a video adapter and/or an audio adapter. An output adapter may be operatively coupled to processor 804 and operatively couplable to an output device such as a display device (e.g., a cathode ray tube (CRT), liquid crystal display (LCD), light emitting diode (LED) display (including OLED), or “electronic ink” display) or an audio output device (e.g., a speaker or headphones).

In some embodiments, media output component 808 may be configured to present a graphical user interface (e.g., a web browser and/or a client application) to user 104, such as user interface 400 shown in FIG. 4. A graphical user interface may include, for example, an interface for viewing instructions or user prompts. This may include any UI components of user interface 400 such as icons 404, 408, 412, 414, and elements 402, 406, 410 (all shown in FIG. 4). In some embodiments, user terminal 802 may include an input device 810 for receiving input from user 104. User 104 may use input device 810 to, without limitation, provide information either through speech or typing.

Input device 810 may include, for example, a keyboard (e.g., physical or digital), a pointing device, a mouse, a stylus, a touch sensitive panel (e.g., a touch pad or a touch screen), a gyroscope, an accelerometer, a position detector, a biometric input device, and/or an audio input device such as a microphone. A single component such as a touch screen may function as both an output device of media output component 808 and input device 810.

User terminal 802 may also include a communication interface 812 operatively/communicatively coupled to a remote device such as computing system 102 (shown in FIG. 1). Communication interface 812 may include, for example, a wired or wireless network adapter and/or a wireless data transceiver for use with a mobile telecommunications network.

Stored in memory area 806 are, for example, computer readable instructions for providing a user interface to user 104 via media output component 808 and, optionally, receiving and processing input from input device 810. A user interface may include, among other possibilities, a web browser and/or a client application. Web browsers enable users, such as user 104, to display and interact with media and other information typically embedded on a web page or a website from a user terminal. A client application may allow user 104 to interact with, for example, a user terminal. For example, instructions may be stored by a cloud service, and the output of the execution of the instructions sent to the media output component 808.

User 104 may make selections and enter text into user interface 400 via input device 810, which may be configured as a software-based, on-screen keyboard (not shown) provided by the OS of the display of a user terminal.

### Exemplary Computer-Implemented Method for Emails

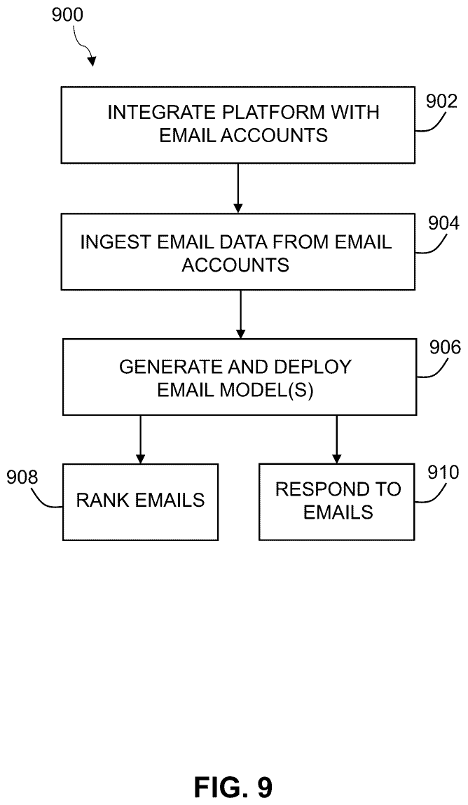

FIG. 9 illustrates a flow chart of an exemplary computer-implemented method 900 implemented by the CDM system 100 (shown in FIG. 1) for the processing and/or management of emails of a user. In the exemplary embodiment, method 900 may be implemented by computing system 102 of CDM system 100.

In the exemplary embodiment, method 900 may include integrating 902 platform 136 with email accounts 116 of user 104. This may include a user 104 downloading or installing software associated with platform 136 to one or more of electronic devices 106-112, and navigating user interface 400 shown in FIG. 4 to establish linkages to the desired email accounts, including selection of other settings such as data time frames and the like.

In the exemplary embodiment, method 900 may include ingesting 904 email data (e.g., from within the overall individual digital data 114) for each of email accounts 116 that were linked to platform 136. This may include ingesting data spanning a certain timeframe based upon settings selected by user 104.

In the exemplary embodiment, method 900 may include generating and deploying 906 one or more email models as part of models 134 based upon the ingested email data. This may include performing the steps described in connection with FIG. 3.

In the exemplary embodiment, method 900 may include performing various email-related tasks via the deployed email models, including ranking 908 emails as shown in FIG. 5 and as described herein and responding 910 to emails on behalf of user 104 as described herein. For example, the output from responding 910 may be platform 136 automatically generating and a prepared response to an email, generated via language generation features of model 134.

### Exemplary Computer-Implemented Method for Calendars

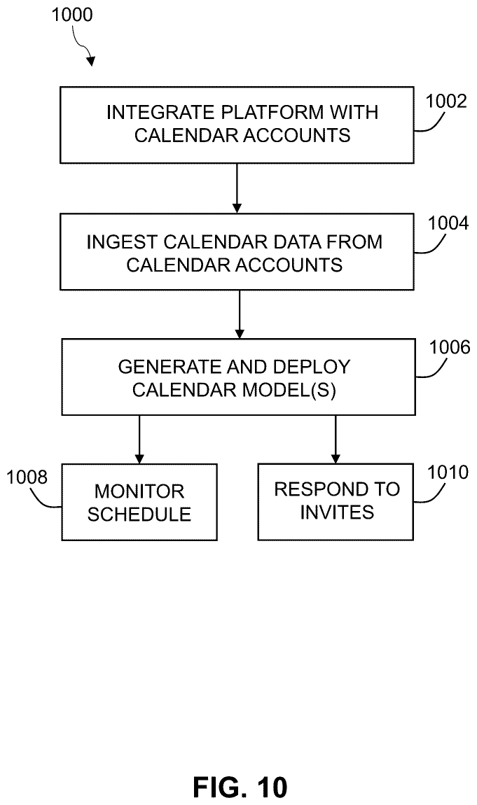

FIG. 10 illustrates a flow chart of an exemplary computer-implemented method 1000 implemented by the CDM system 100 (shown in FIG. 1) for the processing and/or management of calendars of a user. In the exemplary embodiment, method 1000 may be implemented by computing system 102 of CDM system 100.

In the exemplary embodiment, method 1000 may include integrating 1002 platform 136 with calendar accounts 118 of user 104. This may include a user 104 downloading or installing software associated with platform 136 to one or more of electronic devices 106-112, and navigating user interface 400 shown in FIG. 4 to establish linkages to the desired email accounts, including selection of other settings such as data time frames and the like.

In the exemplary embodiment, method 1000 may include ingesting 1004 calendar data (e.g., from within the overall individual digital data 114) for each of calendar accounts 118 that were linked to platform 136. This may include ingesting data spanning a certain timeframe based upon settings selected by user 104.

In the exemplary embodiment, method 1000 may include generating and deploying 1006 one or more calendar models as part of models 134 based upon the ingested calendar data. This may include performing the steps described in connection with FIG. 3.

In the exemplary embodiment, method 1000 may include performing various calendar-related tasks via the deployed calendar models, including monitoring 1008 a schedule of user 104 based upon calendar data and as described herein and responding 1010 to calendar invites on behalf of user 104 as described herein. For example, the output from responding 1010 may be platform 136 automatically accepting or re-scheduling an invite, such as by updating a date/time and/or attendees of a calendar invite.

### Exemplary Computer-Implemented Method for Transportation

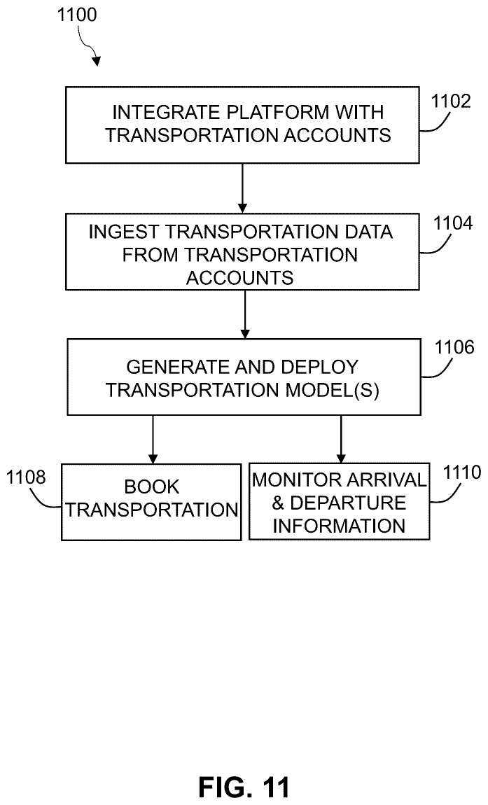

FIG. 11 illustrates a flow chart of an exemplary computer-implemented method 1100 implemented by the CDM system 100 (shown in FIG. 1) for the processing and/or management of transportation of a user. In the exemplary embodiment, method 1100 may be implemented by computing system 102 of CDM system 100.

In the exemplary embodiment, method 1100 may include integrating 1102 platform 136 with transportation accounts 120 of user 104. This may include a user 104 downloading or installing software associated with platform 136 to one or more of electronic devices 106-112, and navigating user interface 400 shown in FIG. 4 to establish linkages to the desired transportation (e.g., airline, rideshare) accounts.

In the exemplary embodiment, method 1100 may include ingesting 1104 transportation data (e.g., from within the overall individual digital data 114) for each of transportation accounts 120 that were linked to platform 136.

In the exemplary embodiment, method 1100 may include generating and deploying 1106 one or more transportation models as part of models 134 based upon the ingested transportation data. This may include performing the steps described in connection with FIG. 3.

In the exemplary embodiment, method 1100 may include performing various transportation-related tasks via the deployed transportation models, including booking 1108 transportation as described herein and monitoring 1110 arrival and/or departure information as described herein. For example, the output from monitoring 1110 may be platform 136 automatically booking 1108 a flight based upon information gleaned or otherwise deciphered by platform 136 from emails and/or calendar invites, and/or automatically booking a rideshare for pickup of user 104 at the airport based upon information gleaned or otherwise deciphered by platform 136 from a transportation account such as an airline account and that indicates an arrival time of the user's flight.

### Exemplary Computer-Implemented Method for Lodging

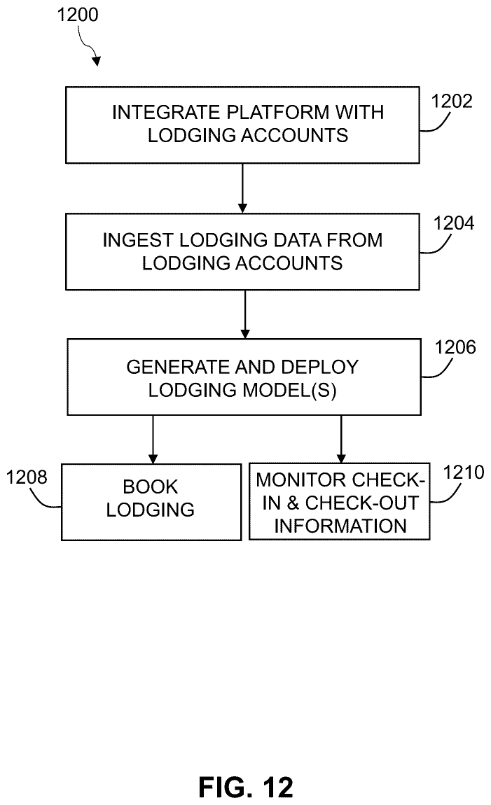

FIG. 12 illustrates a flow chart of an exemplary computer-implemented method 1200 implemented by the CDM system 100 (shown in FIG. 1) for the processing and/or management of lodging of a user. In the exemplary embodiment, method 1200 may be implemented by computing system 102 of CDM system 100.

In the exemplary embodiment, method 1200 may include integrating 1202 platform 136 with lodging accounts 122 of user 104. This may include a user 104 downloading or installing software associated with platform 136 to one or more of electronic devices 106-112, and navigating user interface 400 shown in FIG. 4 to establish linkages to the desired lodging (e.g., hotel, bed and breakfast) accounts.

In the exemplary embodiment, method 1200 may include ingesting 1204 lodging data (e.g., from within the overall individual digital data 114) for each of lodging accounts 122 that were linked to platform 136.

In the exemplary embodiment, method 1200 may include generating and deploying 1206 one or more transportation models as part of models 134 based upon the ingested transportation data. This may include performing the steps described in connection with FIG. 3.

In the exemplary embodiment, method 1200 may include performing various lodging-related tasks via the deployed transportation models, including booking 1208 lodging as described herein and monitoring 1210 check-in and check-out information as described herein. For example, the output from monitoring 1210 may be platform 136 automatically booking 1208 a hotel based upon information gleaned or otherwise deciphered by platform 136 from emails and/or calendar invites, and/or automatically checking-out of a hotel based upon information gleaned or otherwise deciphered by platform 136 from emails and/or calendar invites.

### Exemplary Computer-Implemented Method for Payments

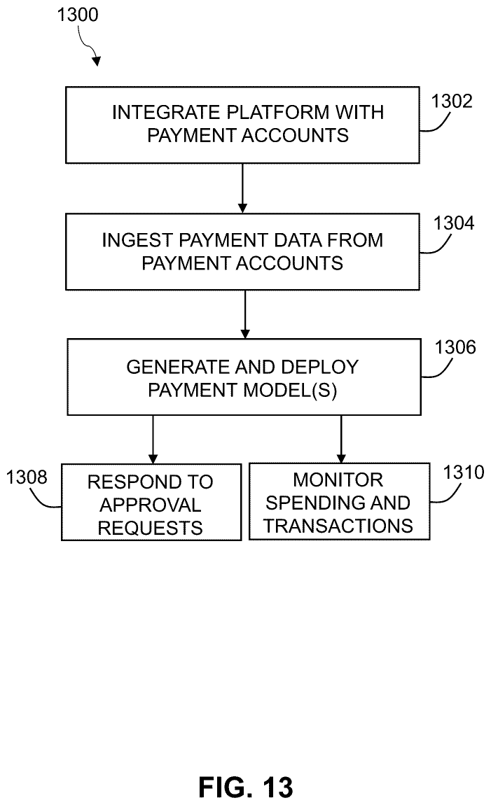

FIG. 13 illustrates a flow chart of an exemplary computer-implemented method 1300 implemented by the CDM system 100 (shown in FIG. 1) for the processing and/or management of payments made by a user. In the exemplary embodiment, method 1300 may be implemented by computing system 102 of CDM system 100.

In the exemplary embodiment, method 1300 may include integrating 1302 platform 136 with payment accounts 124 and/or 126 of user 104. This may include a user 104 downloading or installing software associated with platform 136 to one or more of electronic devices 106-112, and navigating user interface 400 shown in FIG. 4 to establish linkages to the desired payment accounts.

In the exemplary embodiment, method 1300 may include ingesting 1304 payment data (e.g., from within the overall individual digital data 114) for each of payment accounts 122 that were linked to platform 136, where the payment data may also include data of the overall transaction associated with the payment.

In the exemplary embodiment, method 1300 may include generating and deploying 1306 one or more payment models as part of models 134 based upon the ingested payment data. This may include performing the steps described in connection with FIG. 3.

In the exemplary embodiment, method 1300 may include performing various payment-related tasks via the deployed transportation models, including responding 1308 to transaction approval requests as described herein and monitoring 1310 spending and/or transactions as described herein. For example, the output from responding 1308 may be platform 136 automatically responding to an approval request sent by a payment card provider to approve a transaction, such as by platform 136 inputting an OTP to approve a transaction. For example, platform 136 may read the OTP sent in an email to the user's email and automatically input the OTP in a necessary field (e.g., in response email or a response text message) to complete a transaction.

### Artificial Intelligence and Other Matters

The computer-implemented methods discussed herein may include additional, less, or alternate actions, including those discussed elsewhere herein. The methods may be implemented via one or more local or remote processors, transceivers, servers, and/or sensors (such as processors, transceivers, servers, and/or sensors mounted on mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample data sets or certain data into the programs, such as text, voice, image, mobile device, and/or telematics data. The machine learning programs may utilize deep learning algorithms that may be primarily focused on pattern recognition and may be trained after processing multiple examples. The machine learning programs may include Bayesian program learning (BPL), voice recognition and synthesis, image or object recognition, optical character recognition, and/or natural language processing - either individually or in combination. The machine learning programs may also include natural language processing, semantic analysis, automatic reasoning, and/or machine learning.

In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs.

In one embodiment, a processing element may be trained by providing it with a large sample of conventional analog and/or digital, still and/or moving (i.e., video) image data, email data, calendar data, transportation data, telematics data, lodging data, payment data, and/or other account related data with known characteristics or features associated therewith.

Based upon these analyses, the processing element may learn how to identify characteristics and patterns that may then be applied to analyzing account related data, text data, image data, mobile device data, and/or other data. For example, the processing element may learn, with the user's permission or affirmative consent, to identify the features and/or characteristics of the account data, such as by analysis of various accounts that are accessed by the system. As a result, the system is able to learn certain patterns related to analyzing the data and/or outputting responses responding to the data so that the system is able to respond to certain input data in a way that is similar to how the user would respond on their own.

In some embodiments, voice bots or chatbots, such as those discussed herein, may be configured to utilize AI (artificial intelligence) and/or ML (machine learning) techniques. For instance, the chatbot may be a large language model such as OpenAI GPT-4, Meta LLaMa, or Google PaML 2. The voice bot or chatbot may employ supervised or unsupervised ML techniques, which may be followed by, and/or used in conjunction with, reinforced or reinforcement learning techniques. The voice bot or chatbot may employ the techniques utilized for ChatGPT.

### Exemplary Embodiments & Functionality

In one aspect, a computer system for providing customized data management (CDM) may be provided. The computer system may include at least one processor and at least one memory device in communication therewith, the at least one processor in further communication with one or more user computer devices, the at least one processor programmed to: (1) establish a communication link with a computing device associated with at least one user account of a plurality of user accounts associated with a user; (2) receive user data from the at least one user account via the communication link; (3) execute a CDM tool to actively monitor the at least one user account, wherein the CDM tool includes a user-specific artificial intelligence (AI) model trained based upon historical user data associated with the user and the at least one user account; (4) detect, by the CDM tool and the received user data, an event associated with the at least one user account and that the least one user account requires a managed response to the event; (5) in response to the detected event, generate the managed response using the user-specific AI model and without contemporaneous input from the user, the managed response satisfying a condition associated with the detected event; and (6) transmit, via the communication link, the managed response to the computing device associated with the at least one user account.

In another embodiment, the computer system described herein may further include, in combination with any of the other embodiments, the at least one user account is one of an email account, a calendar account, a transportation account, a lodging account, and a payment account.

In another embodiment, the computer system described herein may further include, in combination with any of the other embodiments, the at least one processor further programmed to cause the CDM tool to transmit a user notification to at least one user terminal of the one or more user computer devices associated with the user, wherein the user notification relates to at least one of the event or the managed response.

In another embodiment, the computer system described herein may further include, in combination with any of the other embodiments, the CDM tool including a software application configured to be accessible on at least one user terminal of the one or more user computer devices associated with the user, wherein the software application is configured to cause display of a user interface on the at least one user terminal associated with the user, and wherein the user interface is configured to display to the user a selectable option for enabling or disabling linkage between the CDM tool and the at least one user account.

In another embodiment, the computer system described herein may further include, in combination with any of the other embodiments, the plurality of user accounts includes two or more of an email account, a calendar account, a transportation account, a lodging account, and a payment account; and the user interface is configured to display to the user a plurality of selectable options for enabling or disabling communication linkage between the CDM tool and the respective two or more of the plurality of user accounts.

In another embodiment, the computer system described herein may further include, in combination with any of the other embodiments, the at least one user account being a payment account; wherein the event is a transaction made by the user using the payment account and further includes a transaction approval request; wherein the managed response is a generative text response output from the user-specific AI model that is responsive to the transaction approval request and is generated without contemporaneous input from the user; and wherein the at least one processor is further programmed to cause the generative text response to be transmitted at least in part via the communication link to the computing device.

In another embodiment, the computer system described herein may further include, in combination with any of the other embodiments, the transaction is one of a payment card present transaction associated with the payment account or a payment card-not-present transaction associated with the payment account.

In another embodiment, the computer system described herein may further include, in combination with any of the other embodiments, the at least one processor being further programmed to cause the CDM tool to generate at least one of (i) a user profile including the user or (ii) a group profile including the user and at least one other person.

In another embodiment, the computer system described herein may further include, in combination with any of the other embodiments, the group profile being a household profile including the user.

In another embodiment, the computer system described herein may further include, in combination with any of the other embodiments, the household profile including at least one sub-profile for household spending and household transportation.

In another embodiment, the computer system described herein may further include, in combination with any of the other embodiments, the at least one processor being further programmed to cause the CDM tool to generate at least one of (i) a personal profile for the user and (ii) a professional profile for the user.

In another embodiment, the computer system described herein may further include, in combination with any of the other embodiments, the user data including personal user data of the user and professional user data of the user, and the at least one processor is further programmed to cause the CDM tool to analyze both the personal user data and the professional user data so that an output from the user-specific AI model reflects both the personal user data and the professional user data.

In another embodiment, the computer system described herein may further include, in combination with any of the other embodiments, the at least one user account being an email account; wherein the event is a plurality of emails requiring ranking in order of priority; and wherein the managed response is an output from the CDM tool that is transmitted to the computing device at least in part via the communication link and that causes the plurality of emails to be ranked in order of priority based upon a determination made by the user-specific AI model.

In another embodiment, the computer system described herein may further include, in combination with any of the other embodiments, the CDM tool being configured to output a user interface configured for display on a user terminal of the one or more user computer devices associated with the user, and wherein the at least one processor is further programmed receive an input made by the user via the user interface, the input indicating selection of one or more options presented to the user via the user interface.

In another embodiment, the computer system described herein may further include, in combination with any of the other embodiments, the one or more options include account permissions granted to the CDM tool by the user.

In another aspect, computer-implemented method for providing customized data management (CDM) may be provided. The method being implemented using at least one processor and at least one memory device in communication therewith. The at least one processor in further communication with one or more user computer devices. The method comprising: (1) establishing a communication link with a computing device associated with at least one user account of a plurality of user accounts associated with a user; (2) receiving user data from the at least one user account via the communication link; (3) executing a CDM tool to actively monitor the at least one user account, wherein the CDM tool includes a user-specific artificial intelligence (AI) model trained based upon historical user data associated with the user and the at least one user account; (4) detecting, by the CDM tool and the received user data, an event associated with the at least one user account and that the least one user account requires a managed response to the event; (5) in response to the detected event, generating the managed response using the user-specific AI model and without contemporaneous input from the user, the managed response satisfying a condition associated with the detected event; and (6) transmitting, via the communication link, the managed response to the computing device associated with the at least one user account.

In another embodiment, the computer-implemented method described herein may further include, in combination with any of the other embodiments, the at least one user account being one of an email account, a calendar account, a transportation account, a lodging account, and a payment account.

In another embodiment, the computer-implemented method described herein may further include, in combination with any of the other embodiments, causing the CDM tool to transmit a user notification to at least one user terminal one of the one or more user computer devices associated with the user, wherein the user notification relates to at least one of the event or the managed response.

In another embodiment, the computer-implemented method described herein may further include, in combination with any of the other embodiments, the CDM tool including a software application configured to be accessible on at least one user terminal of the one or more user computer devices associated with the user, wherein the software application is configured to cause display of a user interface on the at least one user terminal associated with the user, and wherein the user interface is configured to display to the user a selectable option for enabling or disabling linkage between the CDM tool and the at least one user account.

In another embodiment, the computer-implemented method described herein may further include, in combination with any of the other embodiments, the plurality of user accounts may include two or more of an email account, a calendar account, a transportation account, a lodging account, and a payment account, and the user interface is configured to display to the user a plurality of selectable options for enabling or disabling linkage between the CDM tool and the respective two or more of the plurality of user accounts.

In another embodiment, the computer-implemented method described herein may further include, in combination with any of the other embodiments, the at least one user account being a payment account; wherein the event is a transaction made by the user using the payment account and further includes a transaction approval request; wherein the managed response is a generative text response output from the user-specific AI model that is responsive to the transaction approval request and is generated without contemporaneous input from the user; and wherein the method further comprises causing the generative text response to be transmitted at least in part via the communication link to the computing device.

In another embodiment, the computer-implemented method described herein may further include, in combination with any of the other embodiments, the transaction being one of a payment card present transaction associated with the payment account or a payment card-not-present transaction associated with the payment account.

In another embodiment, the computer-implemented method described herein may further include, in combination with any of the other embodiments, the method further comprises causing the CDM tool to generate at least one of a user profile including the user or a group profile including the user.

In another embodiment, the computer-implemented method described herein may further include, in combination with any of the other embodiments, the group profile being a household profile including the user.

In another embodiment, the computer-implemented method described herein may further include, in combination with any of the other embodiments, the household profile including at least one sub-profile for household spending and household transportation.

In another embodiment, the computer-implemented method described herein may further include, in combination with any of the other embodiments, the method further comprises causing the CDM tool to generate at least one of a personal profile for the user and a professional profile for the user.

In another embodiment, the computer-implemented method described herein may further include, in combination with any of the other embodiments, the user data including personal user data of the user and professional user data of the user, and the method further comprises causing the CDM tool to comingle the personal user data and the professional user data so that an output from the user-specific AI model reflects both the personal user data and the professional user data.

In another embodiment, the computer-implemented method described herein may further include, in combination with any of the other embodiments, the at least one user account being an email account; wherein the event is a plurality of emails requiring ranking in order of priority; and wherein the managed response is an output from the CDM tool that is transmitted to the computing device at least in part via the communication link and that causes the plurality of emails to be ranked in order of priority based upon a determination made by the user-specific AI model.

In another embodiment, the computer-implemented method described herein may further include, in combination with any of the other embodiments, the CDM tool being configured to output a user interface configured for display on a user terminal of the one or more user computer devices associated with the user, and wherein the method further comprises: receiving an input made by the user via the user interface, the input indicating selection of one or more options presented to the user via the user interface.

In another embodiment, the computer-implemented method described herein may further include, in combination with any of the other embodiments, the one or more options including account permissions granted to the CDM tool by the user.

In another aspect, one or more non-transitory computer-readable storage media for customized data management (CDM) may be provided. The one or more non-transitory computer-readable storage media comprising a plurality of instructions stored thereon that, in response to being executed, cause a computer system to: (1) establish a communication link with a computing device associated with at least one user account of a plurality of user accounts associated with a user; (2) receive user data from the at least one user account via the communication link; (3) execute a CDM tool to actively monitor the at least one user account, wherein the CDM tool includes a user-specific artificial intelligence (AI) model trained based upon historical user data associated with the user and the at least one user account; (4) detect, by the CDM tool, an event associated with the at least one user account and that the least one user account requires a managed response to the event; (5) in response to the detected event, generate the managed response using the user-specific AI model and without contemporaneous input from the user, the managed response satisfying a condition associated with the detected event; and (6) transmit, via the communication link, the managed response to the computing device associated with the at least one user account.

In another embodiment, the non-transitory computer-readable storage media includes instructions stored thereon that, in response to being executed, cause the computer system, in combination with any of the other embodiments, to include at least one user account that is one of an email account, a calendar account, a transportation account, a lodging account, and a payment account.

In another embodiment, the non-transitory computer-readable storage media includes instructions stored thereon that, in response to being executed, cause the computer system, in combination with any of the other embodiments, to: cause the CDM tool to transmit a user notification to at least one user terminal one of the one or more user computer devices associated with the user, wherein the user notification relates to at least one of the event or the manage response.

In another embodiment, the non-transitory computer-readable storage media includes instructions stored thereon that, in response to being executed, cause the computer system, in combination with any of the other embodiments, to include the CDM tool being a software application configured to be accessible on at least one user terminal of the one or more user computer devices associated with the user, wherein the software application is configured to cause display of a user interface on the at least one user terminal associated with the user, and wherein the user interface is configured to display to the user a selectable option for enabling or disabling linkage between the CDM tool and the at least one user account.

In another embodiment, the non-transitory computer-readable storage media includes instructions stored thereon that, in response to being executed, cause the computer system, in combination with any of the other embodiments, to include the plurality of user accounts being two or more of an email account, a calendar account, a transportation account, a lodging account, and a payment account; and the user interface is configured to display to the user a plurality of selectable options for enabling or disabling linkage between the CDM tool and the respective two or more of the plurality of user accounts.

In another embodiment, the non-transitory computer-readable storage media includes instructions stored thereon that, in response to being executed, cause the computer system, in combination with any of the other embodiments, to include the at least one user account being a payment account; wherein the event is a transaction made by the user using the payment account and further includes a transaction approval request; wherein the managed response is a generative text response output from the user-specific AI model that is responsive to the transaction approval request and is generated without contemporaneous input from the user; and wherein the plurality of instructions, in response to being executed, further cause the computer system to cause the generative text response to be transmitted at least in part via the communication link to the computing device.

In another embodiment, the non-transitory computer-readable storage media includes instructions stored thereon that, in response to being executed, cause the computer system, in combination with any of the other embodiments, to include the transaction being one of a card present transaction associated with the payment account or a card not present transaction associated with the payment account.

In another embodiment, the non-transitory computer-readable storage media includes instructions stored thereon that, in response to being executed, cause the computer system, in combination with any of the other embodiments, to cause the CDM tool to generate at least one of a user profile including the user or a group profile including the user.

In another embodiment, the non-transitory computer-readable storage media includes instructions stored thereon that, in response to being executed, cause the computer system, in combination with any of the other embodiments, to include the group profile being a household profile including the user.

In another embodiment, the non-transitory computer-readable storage media includes instructions stored thereon that, in response to being executed, cause the computer system, in combination with any of the other embodiments, to include the household profile being at least one sub-profile for household spending and household transportation.

In another embodiment, the non-transitory computer-readable storage media includes instructions stored thereon that, in response to being executed, cause the computer system, in combination with any of the other embodiments, to cause the CDM tool to generate at least one of a personal profile for the user and a professional profile for the user.

In another embodiment, the non-transitory computer-readable storage media includes instructions stored thereon that, in response to being executed, cause the computer system, in combination with any of the other embodiments, to include the user data being personal user data of the user and professional user data of the user, and the plurality of instructions, in response to being executed, further cause the computer system to cause the CDM tool to comingle the personal user data and the professional user data so that an output from the user-specific AI model reflects both the personal user data and the professional user data.

In another embodiment, the non-transitory computer-readable storage media includes instructions stored thereon that, in response to being executed, cause the computer system, in combination with any of the other embodiments, to include the at least one user account being an email account; wherein the event is a plurality of emails requiring ranking in order of priority; and wherein the managed response is an output from the CDM tool that is transmitted to the computing device at least in part via the communication link and that causes the plurality of emails to be ranked in order of priority based upon a determination made by the user-specific AI model.

In another embodiment, the non-transitory computer-readable storage media includes instructions stored thereon that, in response to being executed, cause the computer system, in combination with any of the other embodiments, to include the CDM tool being configured to output a user interface configured for display on a user terminal of the one or more user computer devices associated with the user, and wherein the plurality of instructions, in response to being executed, further cause the computer system to: receive an input made by the user via the user interface, the input indicating selection of one or more options presented to the user via the user interface.

In another embodiment, the non-transitory computer-readable storage media includes instructions stored thereon that, in response to being executed, cause the computer system, in combination with any of the other embodiments, to include the one or more options being account permissions granted to the CDM tool by the user.

### Additional Considerations

Described herein are computer systems such as the intelligent message routing computer devices and related computer systems. As described herein, all such computer systems include a processor and a memory. However, any processor in a computer device referred to herein can also refer to one or more processors wherein the processor can be in one computing device or a plurality of computing devices acting in parallel or as part of a distributed computing configuration. Additionally, any memory in a computer device referred to herein can also refer to one or more memories wherein the memories can be in one computing device or a plurality of computing devices acting in parallel.

As will be appreciated based upon the foregoing specification, the above-described embodiments of the disclosure may be implemented using computer programming or engineering techniques including computer software, firmware, hardware or any combination or subset thereof. Any such resulting program, having computer-readable code means, may be embodied, or provided within one or more computer-readable media, thereby making a computer program product, i.e., an article of manufacture, according to the discussed embodiments of the disclosure. The computer-readable media may be, for example, but is not limited to, a fixed (e.g., hard) drive, diskette, optical disk, magnetic tape, semiconductor memory such as read-only memory (ROM), and/or any transmitting/receiving medium, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps,” or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor can include any programmable system including systems using micro-controllers, reduced instruction set circuits (RISC), application-specific integrated circuits (ASICs), logic circuits, and any other circuit or processor capable of executing the functions described herein. The above examples are example only and are thus not intended to limit in any way the definition and/or meaning of the term “processor.”

As used herein, the term “database” can refer to either a body of data, a relational database management system (RDBMS), or to both. As used herein, a database can include any collection of data including hierarchical databases, relational databases, flat file databases, object-relational databases, object-oriented databases, and any other structured collection of records or data that is stored in a computer system. The above examples are example only, and thus are not intended to limit in any way the definition and/or meaning of the term database. Examples of RDBMS' include, but are not limited to including, Oracle® Database, MySQL, IBM® DB2, Microsoft® SQL Server, Sybase®, and PostgreSQL. However, any database can be used that enables the systems and methods described herein. (Oracle is a registered trademark of Oracle Corporation, Redwood Shores, California; IBM is a registered trademark of International Business Machines Corporation, CDMonk, New York; Microsoft is a registered trademark of Microsoft Corporation, Redmond, Washington; and Sybase is a registered trademark of Sybase, Dublin, California). The databases described herein may be located within and/or operatively connected to any part of any system described herein, and such location is not limited by what is shown in the figures.

In another example, a computer program is provided, and the program is embodied on a computer-readable medium. In an example, the system is executed on a single computer system, without requiring a connection to a server computer. In a further example, the system is being run in a Windows® environment (Windows is a registered trademark of Microsoft Corporation, Redmond, Washington). In yet another example, the system is run on a mainframe environment and a UNIX® server environment (UNIX is a registered trademark of X/Open Company Limited located in Reading, Berkshire, United Kingdom). In a further example, the system is run on an iOS® environment (iOS is a registered trademark of Cisco Systems, Inc. located in San Jose, CA). In yet a further example, the system is run on a Mac OS® environment (Mac OS is a registered trademark of Apple Inc. located in Cupertino, CA). In still yet a further embodiment, the system is run on Android® OS (Android is a registered trademark of Google, Inc. of Mountain View, CA). In another embodiment, the system is run on Linux® OS (Linux is a registered trademark of Linus Torvalds of Boston, MA). The application is flexible and designed to run in various different environments without compromising any major functionality.

In some examples, the system includes multiple components distributed among a plurality of computer devices. One or more components can be in the form of computer-executable instructions embodied in a computer-readable medium. The systems and processes are not limited to the specific embodiments described herein. In addition, components of each system and each process can be practiced independent and separate from other components and processes described herein. Each component and process can also be used in combination with other assembly packages and processes. The present examples can enhance the functionality and functioning of computers and/or computer systems.

As used herein, an element or step recited in the singular and proceeded with the word “a” or “an” should be understood as not excluding plural elements or steps, unless such exclusion is explicitly recited. Furthermore, references to “example” or “one example” of the present disclosure are not intended to be interpreted as excluding the existence of additional embodiments that also incorporate the recited features.

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

Furthermore, as used herein, the term “real-time” refers to at least one of the time of occurrence of the associated events, the time of measurement and collection of predetermined data, the time to process the data, and the time of a system response to the events and the environment. In the examples described herein, these activities and events occur substantially instantaneously.

The systems and processes are not limited to the specific examples described herein. In addition, components of each system and each process can be practiced independent and separate from other components and processes described herein. Each component and process also can be used in combination with other assembly packages and processes.

The patent claims at the end of this document are not intended to be construed under 35 U.S.C. § 112(f) unless traditional means-plus-function language is expressly recited, such as “means for” or “step for” language being expressly recited in the claim(s).

The computer-implemented methods discussed herein can include additional, less, or alternate actions, including those discussed elsewhere herein. The methods can be implemented via one or more local or remote processors, transceivers, servers, and/or sensors (such as processors, transceivers, servers, and/or sensors mounted on mobile devices, or associated with smart infrastructure or remote servers), and/or via computer-executable instructions stored on non-transitory computer-readable media or medium. Additionally, the computer systems discussed herein can include additional, less, or alternate functionality, including that discussed elsewhere herein. The computer systems discussed herein may include or be implemented via computer-executable instructions stored on non-transitory computer-readable media or medium.

As used herein, the term “non-transitory computer-readable media” is intended to be representative of any tangible computer-based device implemented in any method or technology for short-term and long-term storage of information, such as, computer-readable instructions, data structures, program modules and sub-modules, or other data in any device. Therefore, the methods described herein can be encoded as executable instructions embodied in a tangible, non-transitory, computer readable medium, including, without limitation, a storage device and/or a memory device. Such instructions, when executed by a processor, cause the processor to perform at least a portion of the methods described herein. Moreover, as used herein, the term “non-transitory computer-readable media” includes all tangible, computer-readable media, including, without limitation, non-transitory computer storage devices, including, without limitation, volatile and nonvolatile media, and removable and non-removable media such as a firmware, physical and virtual storage, CD-ROMs, DVDs, and any other digital source such as a network or the Internet, as well as yet to be developed digital means, with the sole exception being a transitory, propagating signal.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A computer system for providing customized data management (CDM), the computer system comprising at least one processor and at least one memory device in communication therewith, the at least one processor in further communication with one or more user computer devices, the at least one processor programmed to:
establish a communication link with a computing device associated with at least one user account of a plurality of user accounts associated with a user;
receive user data from the at least one user account via the communication link;
execute a CDM tool to actively monitor the at least one user account, wherein the CDM tool includes a user-specific artificial intelligence (AI) model trained based upon historical user data associated with the user and the at least one user account;
detect, by the CDM tool and the received user data, an event associated with the at least one user account and that the least one user account requires a managed response to the event;
in response to the detected event, generate the managed response using the user-specific AI model and without contemporaneous input from the user, the managed response satisfying a condition associated with the detected event; and
transmit, via the communication link, the managed response to the computing device associated with the at least one user account.

2. The computer system of claim 1, wherein the at least one user account is one of an email account, a calendar account, a transportation account, a lodging account, and a payment account.

3. The computer system of claim 1, wherein the at least one processor is further programmed to:
cause the CDM tool to transmit a user notification to at least one user terminal of the one or more user computer devices associated with the user, wherein the user notification relates to at least one of the event or the managed response.

4. The computer system of claim 1, wherein the CDM tool includes a software application configured to be accessible on at least one user terminal of the one or more user computer devices associated with the user,
wherein the software application is configured to cause display of a user interface on the at least one user terminal associated with the user, and wherein the user interface is configured to display to the user a selectable option for enabling or disabling linkage between the CDM tool and the at least one user account.

5. The computer system of claim 4, wherein the plurality of user accounts includes two or more of an email account, a calendar account, a transportation account, a lodging account, and a payment account; and
the user interface is configured to display to the user a plurality of selectable options for enabling or disabling communication linkage between the CDM tool and the respective two or more of the plurality of user accounts.

6. The computer system of claim 1, wherein the at least one user account is a payment account;
wherein the event is a transaction made by the user using the payment account and further includes a transaction approval request;
wherein the managed response is a generative text response output from the user-specific AI model that is responsive to the transaction approval request and is generated without contemporaneous input from the user; and
wherein the at least one processor is further programmed to cause the generative text response to be transmitted at least in part via the communication link to the computing device.

7. The computer system of claim 6, wherein the transaction is one of a payment card present transaction associated with the payment account or a payment card-not-present transaction associated with the payment account.

8. The computer system of claim 1, wherein the at least one processor is further programmed to cause the CDM tool to generate at least one of (i) a user profile including the user or (ii) a group profile including the user and at least one other person.

9. The computer system of claim 8, wherein the group profile is a household profile including the user.

10. The computer system of claim 9, wherein the household profile includes at least one sub-profile for household spending and household transportation.

11. The computer system of claim 1, wherein the at least one processor is further programmed to cause the CDM tool to generate at least one of (i) a personal profile for the user and (ii) a professional profile for the user.

12. The computer system of claim 11, wherein the user data includes personal user data of the user and professional user data of the user, and the at least one processor is further programmed to cause the CDM tool to analyze both the personal user data and the professional user data so that an output from the user-specific AI model reflects both the personal user data and the professional user data.

13. The computer system of claim 1, wherein the at least one user account is an email account;
wherein the event is a plurality of emails requiring ranking in order of priority; and
wherein the managed response is an output from the CDM tool that is transmitted to the computing device at least in part via the communication link and that causes the plurality of emails to be ranked in order of priority based upon a determination made by the user-specific AI model.

14. The computer system of claim 1, wherein the CDM tool is configured to output a user interface configured for display on a user terminal of the one or more user computer devices associated with the user, and wherein the at least one processor is further programmed:
receive an input made by the user via the user interface, the input indicating selection of one or more options presented to the user via the user interface.

15. The computer system of claim 14, wherein the one or more options include account permissions granted to the CDM tool by the user.

16. A computer-implemented method for providing customized data management (CDM), the method being implemented using at least one processor and at least one memory device in communication therewith, the at least one processor in further communication with one or more user computer devices, the method comprising:
establishing a communication link with a computing device associated with at least one user account of a plurality of user accounts associated with a user;
receiving user data from the at least one user account via the communication link;
executing a CDM tool to actively monitor the at least one user account, wherein the CDM tool includes a user-specific artificial intelligence (AI) model trained based upon historical user data associated with the user and the at least one user account;
detecting, by the CDM tool and the received user data, an event associated with the at least one user account and that the least one user account requires a managed response to the event;
in response to the detected event, generating the managed response using the user-specific AI model and without contemporaneous input from the user, the managed response satisfying a condition associated with the detected event; and
transmitting, via the communication link, the managed response to the computing device associated with the at least one user account.

17. The computer-implemented method of claim 16, wherein the at least one user account is one of an email account, a calendar account, a transportation account, a lodging account, and a payment account.

18. The computer-implemented method of claim 16, further comprising:
causing the CDM tool to transmit a user notification to at least one user terminal one of the one or more user computer devices associated with the user, wherein the user notification relates to at least one of the event or the managed response.

19. The computer-implemented method of claim 16, wherein the CDM tool includes a software application configured to be accessible on at least one user terminal of the one or more user computer devices associated with the user, wherein the software application is configured to cause display of a user interface on the at least one user terminal associated with the user, and wherein the user interface is configured to display to the user a selectable option for enabling or disabling linkage between the CDM tool and the at least one user account.

20. The computer-implemented method of claim 19, wherein the plurality of user accounts includes two or more of an email account, a calendar account, a transportation account, a lodging account, and a payment account, and the user interface is configured to display to the user a plurality of selectable options for enabling or disabling linkage between the CDM tool and the respective two or more of the plurality of user accounts.

21. One or more non-transitory computer-readable storage media for providing customized data management (CDM), the one or more non-transitory computer-readable storage media comprising a plurality of instructions stored thereon that, in response to being executed, cause at least one processor of a computer system to:
establish a communication link with a computing device associated with at least one user account of a plurality of user accounts associated with a user;
receive user data from the at least one user account via the communication link;
execute a CDM tool to actively monitor the at least one user account, wherein the CDM tool includes a user-specific artificial intelligence (AI) model trained based upon historical user data associated with the user and the at least one user account;
detect, by the CDM tool and the received user data, an event associated with the at least one user account and that the least one user account requires a managed response to the event;
in response to the detected event, generate the managed response using the user-specific AI model and without contemporaneous input from the user, the managed response satisfying a condition associated with the detected event; and
transmit, via the communication link, the managed response to the computing device associated with the at least one user account.
